(19) United States
(12) Patent Application Publication
(10) Pub. No.: US 2022/0294749 A1
(43) Pub. Date: Sep. 15, 2022

(54) COMPUTER-READABLE RECORDING MEDIUM STORING CONVERSATION CONTROL PROGRAM, CONVERSATION CONTROL METHOD, AND INFORMATION PROCESSING DEVICE

(71) Applicant: FUJITSU LIMITED, Kawasaki-shi (JP)

(72) Inventors: YUKO HORIZOE, Yokohama (JP); Kazuhiro Nakamura, Ota (JP); SHINJI NARUKAWA, Ota (JP)

(73) Assignee: FUJITSU LIMITED, Kawasaki-shi (JP)

(21) Appl. No.: 17/828,294

(22) Filed: May 31, 2022

Related U.S. Application Data
(63) Continuation of application No. PCT/JP2019/051290, filed on Dec. 26, 2019.

(51) Int. Cl. H04L 51/02; G06F 9/54

(52) U.S. Cl. CPC H04L 51/02; G06F 9/546

(57) ABSTRACT

A non-transitory computer-readable recording medium stores a conversation control program for causing a computer to execute processing including: receiving a chat start instruction from a first information processing terminal and receiving user information acquired by the first information processing terminal; starting a first conversation with a chatbot in the first information processing terminal in response to the chat start instruction; in a case of receiving transfer information that indicates transfer from the first conversation from a second information processing terminal, starting a second conversation that follows the first conversation with the chatbot in the second information processing terminal on the basis of the transfer information; and starting display of different information from the first conversation or different processing from the first conversation in the first information processing terminal on the basis of the received user information.

### CROSS-REFERENCE TO RELATED APPLICATION

This application is a continuation application of International Application PCT/JP2019/051290 filed on Dec. 26, 2019 and designated the U.S., the entire contents of which are incorporated herein by reference.

### FIELD

The embodiment discussed herein is related to a conversation control program, a conversation control method, and an information processing device.

### BACKGROUND

In recent years, digital boards capable of two-way communication linked with chatbots have begun to be used. The digital boards are used, for example, to guide stores and facilities. Furthermore, the digital boards are installed in highly public places such as government offices, train stations, and towns, and are expected to be used by an unspecified number of people.

Japanese Laid-open Patent Publication No. 2016-35781 and Japanese Laid-open Patent Publication No. 2018-41453 are disclosed as related art.

### SUMMARY

According to an aspect of the embodiments, a non-transitory computer-readable recording medium stores a conversation control program for causing a computer to execute processing including: receiving a chat start instruction from a first information processing terminal and receiving user information acquired by the first information processing terminal; starting a first conversation with a chatbot in the first information processing terminal in response to the chat start instruction; in a case of receiving transfer information that indicates transfer from the first conversation from a second information processing terminal, starting a second conversation that follows the first conversation with the chatbot in the second information processing terminal on the basis of the transfer information; and starting display of different information from the first conversation or different processing from the first conversation in the first information processing terminal on the basis of the received user information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of a conversation control method according to an embodiment;

FIG. 2 is an explanatory diagram illustrating a system configuration example of a conversation control system 200;

FIG. 3 is a block diagram illustrating a hardware configuration example of an information processing device 101;

FIG. 4 is a block diagram illustrating a hardware configuration example of an information processing terminal 201;

FIG. 5 is an explanatory diagram illustrating an example of stored content of a script table 240;

FIG. 6 is an explanatory diagram illustrating a specific example of script information;

FIG. 7 is an explanatory diagram illustrating an example of stored content of a script transfer table 250;

FIG. 8 is a block diagram illustrating a functional configuration example of the information processing device 101;

FIG. 9 is an explanatory diagram illustrating an operation example of the conversation control system 200;

FIG. 10 is an explanatory diagram (part 1) illustrating a screen example of a conversation screen displayed on a first information processing terminal 201;

FIG. 11 is an explanatory diagram (part 2) illustrating a screen example of the conversation screen displayed on the first information processing terminal 201;

FIG. 12 is an explanatory diagram (part 3) illustrating a screen example of the conversation screen displayed on the first information processing terminal 201;

FIG. 13 is an explanatory diagram (part 1) illustrating a screen example of a conversation screen displayed on a second information processing terminal 202;

FIG. 14 is an explanatory diagram (part 2) illustrating a screen example of the conversation screen displayed on the second information processing terminal 202;

FIG. 15 is an explanatory diagram (part 4) illustrating a screen example of the conversation screen displayed on the first information processing terminal 201;

FIG. 16 is an explanatory diagram (part 5) illustrating a screen example of the conversation screen displayed on the first information processing terminal 201;

FIG. 17 is an explanatory diagram (part 6) illustrating a screen example of the conversation screen displayed on the first information processing terminal 201;

FIG. 18 is an explanatory diagram (part 7) illustrating a screen example of the conversation screen displayed on the first information processing terminal 201;

FIG. 19 is a flowchart (part 1) illustrating an example of a first conversation control processing procedure of the information processing device 101;

FIG. 20 is a flowchart (part 2) illustrating an example of a first conversation control processing procedure of the information processing device 101; and

FIG. 21 is a flowchart illustrating an example of a second conversation control processing procedure of the information processing device 101.

### DESCRIPTION OF EMBODIMENTS

As an existing technique, there is a mobile terminal that transmits, when receiving an instruction to transmit identification information for identifying displayed content information while displaying the content information, the identification information for identifying the content information to an external information device and performs control to terminate the display of the content information.

Furthermore, there is a technique of displaying, on a screen for displaying content transmitted and received in a group including a user of a terminal and a user of another terminal, user information of the users included in the group as candidates to be designated, associating the user information selected from the candidates with first content, transmitting the first content, and displaying second content in a mode different from other pieces of content in a case where the received second content is associated with the user information of the terminal.

However, there are some cases where provision of services using two-way communication linked with chatbots using digital boards or the like installed in a place expected to be used by an unspecified number of users is restricted. For example, when inputting personal information, it is desirable to let an individually owned personal terminal take over the processing from the viewpoint of information protection. Meanwhile, in a case where a parent or the like with children uses the service, there is a problem that the parent must pay attention to the children while using the service while handling a subsequent chat on the personal terminal.

In one aspect, an object of the embodiment is to achieve smooth use of services using chatbots.[0011] Hereinafter, embodiments of a conversation control program, a conversation control method, and an information processing device will be described in detail with reference to the drawings.

### Embodiment

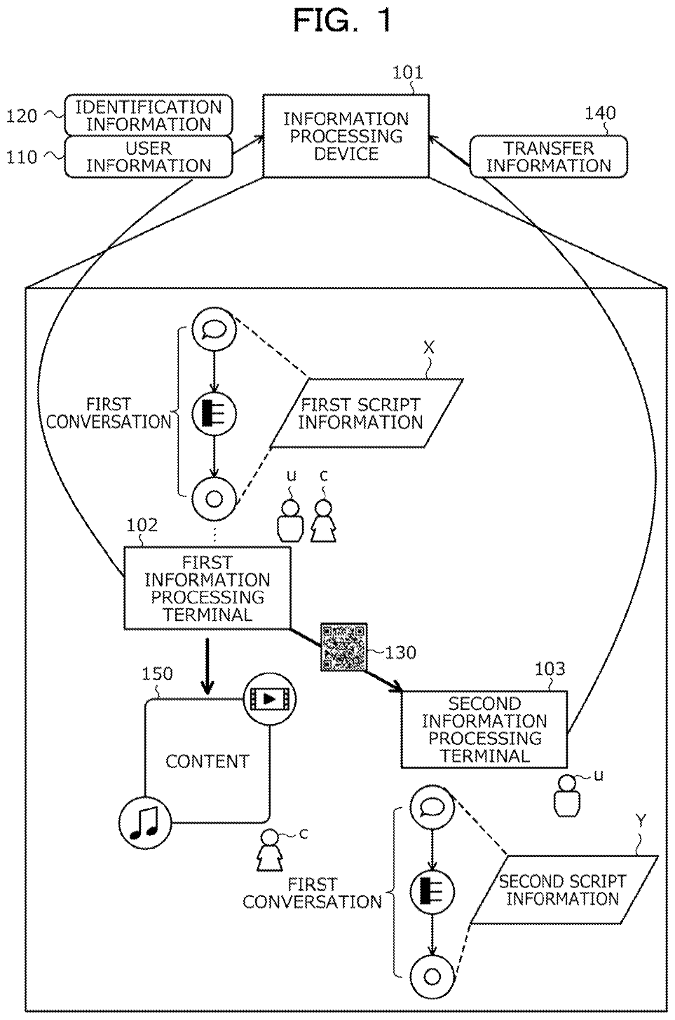

FIG. 1 is an explanatory diagram illustrating an example of a conversation control method according to an embodiment. In FIG. 1, an information processing device 101 is a computer that controls a conversation of a chatbot. The chatbot is a computer system that interacts with and exchanges messages with humans using artificial intelligence.

A first information processing terminal 102 is a computer that a user uses to have a conversation with the chatbot. For example, the first information processing terminal 102 is installed in a highly public place such as a station or an airport or a place where goods and services are provided such as a store or a commercial facility, and is used by an unspecified number of people.

The first information processing terminal 102 may be a stationary information processing terminal or a portable information processing terminal. More specifically, for example, the first information processing terminal 102 is a digital board equipped with a large touch panel display, a tablet personal computer (PC) rented out to the user at a store, or the like.

A second information processing terminal 103 is a computer that the user uses to have a conversation with the chatbot. For example, the second information processing terminal 103 is a smartphone, tablet PC, or the like that the individual user owns. Note that the second information processing terminal 103 may be rented out to the user at a store or the like.

Here, it is conceivable to use the first information processing terminal 102 to provide a service using two-way communication linked with the chatbot. Examples of the service include a service that accepts inquiries and applications from users who visit airports, stores, government offices, or the like, and a service that introduces recommended stores and facilities.

However, inputting personal information in the first information processing terminal 102, which is installed in a highly public place and is expected to be used by an unspecified number of people, is not desirable from the viewpoint of information protection. Furthermore, in a case of using a service that requires troublesome procedures, there is a possibility that the user may not be able to perform the operation smoothly or the user may be impatient and erroneously operate the terminal if the user is not accustomed to using the first information processing terminal 102.

Therefore, it is conceivable to let the smartphone or the tablet PC that the individual user owns take over the processing in the case of inputting the personal information or using the service that requires troublesome procedures. Thereby, it becomes possible to prevent the personal information from being stolen at the time of input or to allow the user to go through the troublesome procedures on the familiar terminal.

Meanwhile, there are some cases where the user has a companion. For example, in the case where the user with children uses the service, he/she must pay attention to the children while using the service so as not to encounter any incident or accident while handling a subsequent chat on the personal terminal. Furthermore, even if the companion is an adult, the user may be impatient and erroneously operate the terminal or give up using the service because he/she feels sorry for making the companion wait.

Therefore, in the present embodiment, a conversation control method for achieving smooth use of a service using a chatbot by continuing to respond to the companion in the first information processing terminal 102 even after transferring a conversation with the chatbot from the first information processing terminal 102 to the second information processing terminal 103 will be described. Hereinafter, a processing example of the information processing device 101 will be described.

(1) The information processing device 101 receives a chat start instruction from the first information processing terminal 102 and also receives user information acquired by the first information processing terminal 102. Here, the chat start instruction is for starting a conversation between the user and the chatbot.

The user information is information regarding the user who uses the first information processing terminal 102. For example, the user information includes information that identifies the presence or absence of a companion. The companion is, for example, a child, a family member, a friend, or the like who accompanies the user. Specifically, for example, the user information may include information representing characteristics of the user. Furthermore, the user information may include information representing characteristics of the companion.

The information representing characteristics of the user or the companion is, for example, information that identifies the age, generation, gender, language, clothing, presence or absence of a wheelchair, and the like of the user or the companion. Furthermore, the user information may include position information (latitude, longitude, altitude, and the like) indicating a user's current position, and meteorological information (temperature, humidity, weather, and the like) of a user's current position.

Furthermore, the information processing device 101 may further receive identification information corresponding to the first information processing terminal 102 as well as receiving the chat start instruction from the first information processing terminal 102. The identification information corresponding to the first information processing terminal 102 is, for example, information indicating that the first information processing terminal 102 is installed in a highly public place, a store, or a commercial facility. Furthermore, the identification information corresponding to the first information processing terminal 102 may be information that uniquely identifies the first information processing terminal 102.

The identification information corresponding to the first information processing terminal 102 is, for example, one of pieces of information for determining script information to be applied to the conversation of the chatbot in the first information processing terminal 102. The script information is information (scenario) that defines processing related to the conversation of the chatbot. Specifically, for example, the script information is information that defines a flow of chat talk processing.

The example of FIG. 1 assumes a case of receiving user information 110 acquired by the first information processing terminal 102 and identification information 120 corresponding to the first information processing terminal 102 from the first information processing terminal 102 together with the chat start instruction. Note that, in FIG. 1, a user u is a user who uses a service linked with the chatbot. A companion c is a person who accompanies the user u.

(2) The information processing device 101 starts a first conversation with the chatbot in the first information processing terminal 102 in response to the chat start instruction. Specifically, for example, the information processing device 101 determines first script information on the basis of the received identification information 120 corresponding to the first information processing terminal 102.

The first script information is script information applied to the conversation of the chatbot in the first information processing terminal 102. Then, the information processing device 101 starts the first conversation by using the determined first script information. on the first information processing terminal 102, the user has the conversation with the chatbot by selecting an option or inputting a message.

Here, the identification information 120 is assumed to be information indicating that the first information processing terminal 102 is installed in a highly public place. In this case, the information processing device 101 may determine, for example, the script information stored in advance for the terminal installed in the highly public place as the first script information.

Furthermore, the identification information 120 is assumed to be information indicating that the first information processing terminal 102 is installed in a specific store. In this case, the information processing device 101 may determine, for example, the script information stored in advance for the terminal installed in the specific store as the first script information.

Furthermore, the identification information 120 is assumed to be a terminal ID that uniquely identifies the first information processing terminal 102. In this case, the information processing device 101 may determine, for example, the script information stored in advance in association with the terminal ID of the first information processing terminal 102 as the first script information.

The example of FIG. 1 assumes a case where first script information X is determined on the basis of the identification information 120. In this case, the information processing device 101 uses the first script information X to start the first conversation with the chatbot in the first information processing terminal 102. The first conversation is, for example, an open chat conversation held in the highly public place. In open chat, for example, questions about highly confidential personal information are not asked.

(3) The information processing device 101 receives transfer information from the second information processing terminal 103. Here, the transfer information is information indicating a transfer from the first conversation. The transfer information includes, for example, information that identifies the first script information. Furthermore, the transfer information may include information that specifies a point where the first conversation has been interrupted, a conversation history of the first conversation, and the like.

The second information processing terminal 103 acquires the transfer information indicating a transfer from the first conversation with the chatbot in the first information processing terminal 102 by reading a transfer guidance output from the first information processing terminal 102, for example. For example, the transfer information is acquired on the basis of the transfer guidance read by the second information processing terminal 103.

The transfer guidance interrupts the conversation in the open chat and encourages a subsequent conversation in a closed chat performed on the smartphone that the user owns or the like. In closed chat, for example, questions about more confidential personal information can be asked than in the open chat.

For example, the transfer guidance is output from the first information processing terminal 102 in a case where conversation content satisfies a predetermined condition after the start of the first conversation. More specifically, for example, the transfer guidance is displayed on the first information processing terminal 102 as a two-dimensional code such as a quick response (QR) code. The QR code is a registered trademark.

The example of FIG. 1 assumes a case where the second information processing terminal 103 acquires transfer information 140 indicating the transfer from the first conversation with the chatbot in the first information processing terminal 102 by reading a QR code 130 displayed on the first information processing terminal 102. Then, the example assumes a case where the information processing device 101 receives the transfer information 140 from the second information processing terminal 103.

(4) In the case of receiving the transfer information from the second information processing terminal 103, the information processing device 101 starts a second conversation following the first conversation with the chatbot in the second information processing terminal 103 on the basis of the transfer information. Specifically, for example, the information processing device 101 determines second script information on the basis of the received transfer information 140.

The second script information is script information applied to the conversation of the chatbot in the second information processing terminal 103. Then, the information processing device 101 starts the second conversation following the first conversation using the determined second script information. In the second information processing terminal 103, the user has the conversation with the chatbot by selecting an option or inputting a message.

It is assumed that the transfer information 140 includes, for example, information that identifies the first script information X. In this case, the information processing device 101 may determine, for example, the script stored in advance in association with the first script information X as the second script information.

Furthermore, it is assumed that the transfer information 140 includes information for identifying the first script information X and information that specifies the point where the first conversation has been interrupted (transfer point). In this case, the information processing device 101 may determine the script information corresponding to the transfer point specified from the transfer information 140 among the script information stored in advance in association with the transfer point of the first script information X as the second script information, for example.

Note that the second script information may define a flow of the conversation of and after the transfer point in the first script information. For example, the point of and after the transfer point of the first script information may be used as the second script information instead of separately preparing the first script information and the second script information.

The example of FIG. 1 assumes a case where second script information Y is determined from the transfer information 140. In this case, the information processing device 101 uses the second script information Y to start the second conversation following the first conversation with the chatbot in the second information processing terminal 103. The second conversation is a closed chat conversation. As a result, the user u can input the personal information or go through troublesome procedures on the second information processing terminal 103.

(5) The information processing device 101 starts display of information different from the first conversation or processing different from the first conversation on the first information processing terminal 102 on the basis of the received user information. Here, the information different from the first conversation is information displayed to the companion, and is, for example, a message or an image having content different from the first conversation.

Furthermore, the processing different from the first conversation is processing performed for the companion, and is, for example, processing of outputting information different from the first conversation or accepting input of information different from the first conversation. The companion is a person who accompanies the user who performs the second conversation following the first conversation with the chatbot in the second information processing terminal 103, and is, for example, a child, a family member, a friend, or the like of the user.

Specifically, for example, in a case where the user information indicates that the user has a companion, the information processing device 101 starts display of the information different from the first conversation or the processing different from the first conversation on the first information processing terminal 102. At this time, the information processing device 101 may start display of the information different from the first conversation or the processing different from the first conversation on the first information processing terminal 102 after starting the second conversation on the second information processing terminal 103.

The display of the information different from the first conversation or the processing different from the first conversation is implemented by the first script information, for example. For example, the first script information may description of processing for displaying the information different from the first conversation or the processing different from the first conversation.

Note that the display of the information different from the first conversation or the processing different from the first conversation may be implemented by the script information different from the first script information. Furthermore, the display of the information different from the first conversation or the processing different from the first conversation may be implemented in a format (video playback, music playback, or the like) different from a conversation format with the chatbot.

Note that, in a case where the user information indicates that the user has no companion, the information processing device 101 does not start the display of the information different from the first conversation or the processing different from the first conversation on the first information processing terminal 102. In this case, the information processing device 101 may terminate the first conversation with the chatbot in the first information processing terminal 102.

The example of FIG. 1 assumes a case where the user information 110 indicates that the user u has the companion c. In this case, the information processing device 101 starts the second conversation in the second information processing terminal 103, and then starts playback of content 150 in the first information processing terminal 102. The content 150 is information for the companion c, displays information different from the first conversation and accepts input of information different from the first conversation. For example, the content 150 may display information for children or perform processing for children. Furthermore, the content 150 may display information for foreign tourists or perform processing for foreign tourists.

In this way, the information processing device 101 enables transfer of the chat between different devices. For example, the information processing device 101 enables transfer of the conversation with the chatbot from the first information processing terminal 102 installed in the highly public place to the second information processing terminal 103 that the individual user owns. Thereby, for example, in the case of inputting personal information, the personal information can be prevented from being stolen by a third party by the transfer of the conversation with the chatbot from the first information processing terminal 102 to the second information processing terminal 103.

Furthermore, the information processing device 101 can entertain the companion by displaying or processing information that attracts the companion's interest while the user is handling a subsequent chat on the second information processing terminal 103 in the case where the user has the companion.

In the example of FIG. 1, the content 150 can be provided to the first information processing terminal 102 for the companion c while the user u is handling a subsequent chat on the second information processing terminal 103. Thereby, it is possible to achieve smooth use of the service using the chatbot by continuing to respond to the companion c in the first information processing terminal 102 even after transferring the conversation with the chatbot to the second information processing terminal 103.

(System Configuration Example of Conversation Control System 200)

Next, a system configuration example of a conversation control system 200 including the information processing device 101 illustrated in FIG. 1 will be described. The conversation control system 200 is applied to, for example, a computer system that provides a service using two-way communication linked with a chatbot.

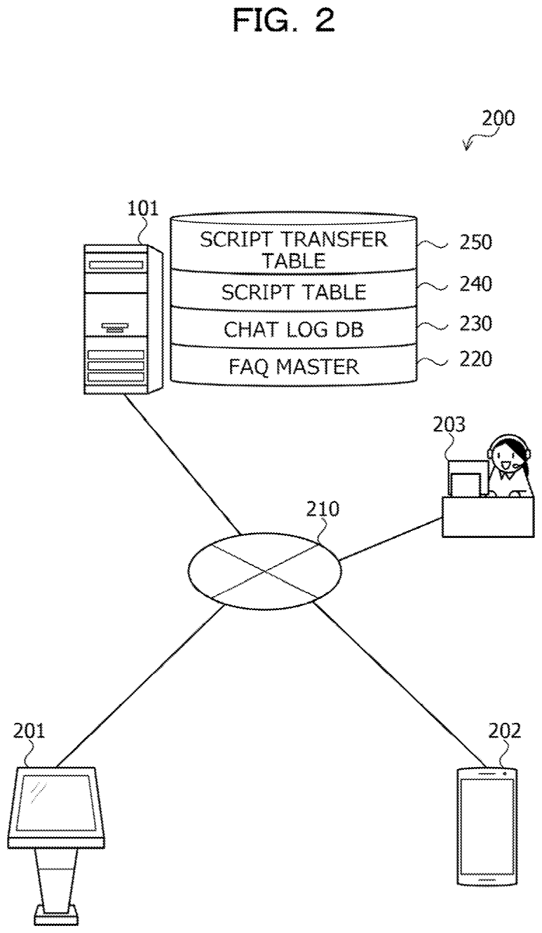

FIG. 2 is an explanatory diagram illustrating a system configuration example of the conversation control system 200. In FIG. 2, the conversation control system 200 includes the information processing device 101, a first information processing terminal 201, a second information processing terminal 202, and an operator terminal 203. In the conversation control system 200, the information processing device 101, the first information processing terminal 201, the second information processing terminal 202, and the operator terminal 203 are connected via a wired or wireless network 210. The network 210 is, for example, a local area network (LAN), a wide area network (WAN), the Internet, or the like.

Here, the information processing device 101 has a frequently asked question (FAQ) master 220, a chat log database (DB) 230, a script table 240, and a script transfer table 250, and controls the conversation of the chatbot. For example, the information processing device 101 is a server.

The FAQ master 220 stores FAQ. The FAQ means “frequently asked questions”, and is a collection of question data and answer data for questions expected in advance. The question may ask for a solution method to some problem, or it may be a spoken question. The answers include an answer indicating a solution method to the asked question and an answer to the spoken question.

The chat log DB 230 stores a chat log. The chat log is a conversation history regarding the conversation between the user and the chatbot. The chat log is stored in the chat log DB 230 in association with a room ID, for example. The room ID can specify a series of conversations with the chatbot.

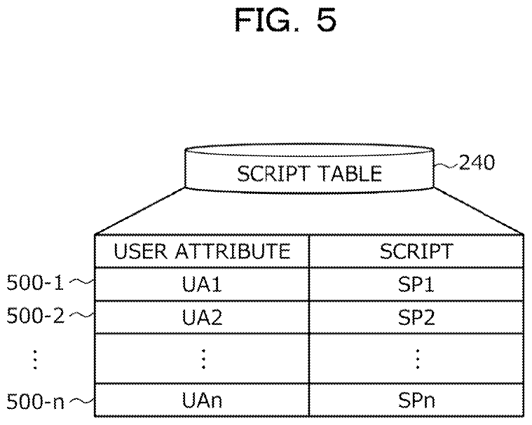

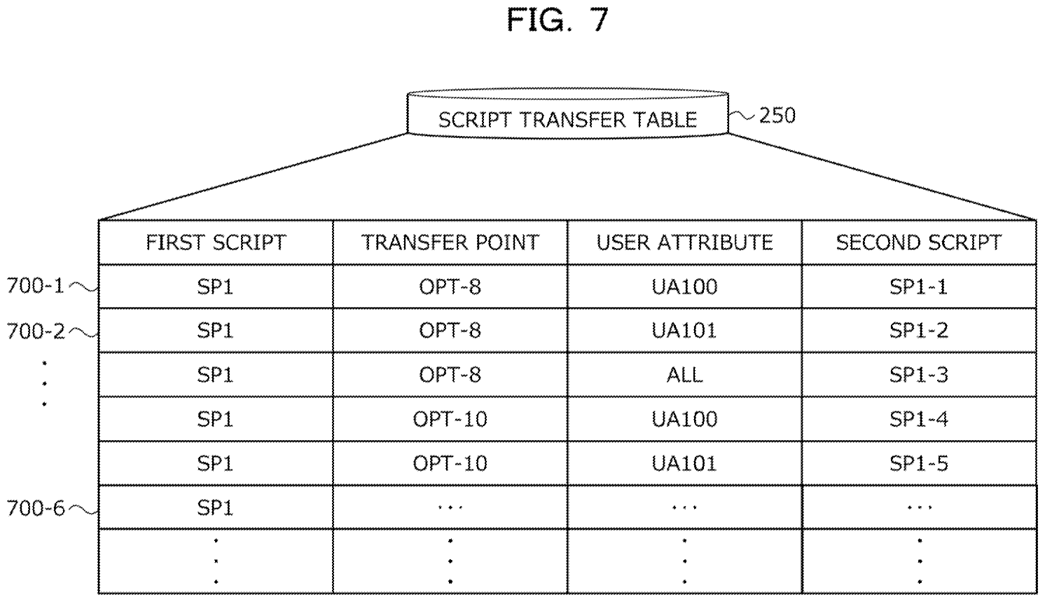

Note that stored content of the script table 240 and the script transfer table 250 will be described below with reference to FIGS. 5 and 7.

The first information processing terminal 201 is a computer that the user uses to have the conversation with the chatbot. For example, the first information processing terminal 201 is installed in the highly public place, store, commercial facility, or the like, and is used by an unspecified number of people. The first information processing terminal 102 illustrated in FIG. 1 corresponds to, for example, the first information processing terminal 201.

The second information processing terminal 202 is a computer that the user uses to have the conversation with the chatbot. For example, the second information processing terminal 202 is a smartphone, a tablet PC, or the like that the individual user owns. The second information processing terminal 103 illustrated in FIG. 1 corresponds to, for example, the second information processing terminal 202.

The operator terminal 203 is a computer that an operator uses. The operator is a person who responds to the user when the conversation is switched from the conversation by the chatbot to a manned conversation. For example, the operator can communicate with the user by using a telephone function of the operator terminal 203, text communication, or the like. For example, the operator terminal 203 is a PC or a tablet PC.

Note that, here, only one first information processing terminal 201, one second information processing terminal 202, and one operator terminal 203 are displayed, but the numbers of the terminals are not limited thereto. For example, the conversation control system 200 may include a plurality of the first information processing terminals 201, the second information processing terminals 202, and the operator terminals 203. For example, a plurality of the first information processing terminals 201 may be installed in each place where the service using two-way communication linked with a chatbot is provided.

(Hardware Configuration Example of Information Processing device 101)

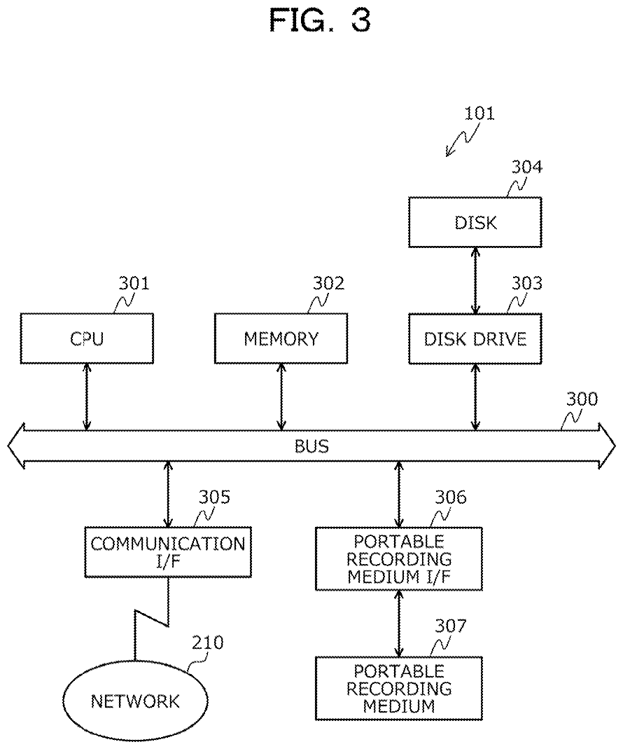

FIG. 3 is a block diagram illustrating a hardware configuration example of the information processing device 101. In FIG. 3, the information processing device 101 includes a central processing unit (CPU) 301, a memory 302, a disk drive 303, a disk 304, a communication interface (I/F) 305, a portable recording medium I/F 306, and a portable recording medium 307. Furthermore, the individual components are connected to each other by a bus 300.

Here, the CPU 301 performs overall control of the information processing device 101. The CPU 301 may include a plurality of cores. The memory 302 includes, for example, a read only memory (ROM), a random access memory (RAM), a flash ROM, and the like. Specifically, for example, the flash ROM stores an operating system (OS) program, the ROM stores an application program, and the RAM is used as a work area for the CPU 301. The program stored in the memory 302 is loaded to the CPU 301 to cause the CPU 301 to execute coded processing.

The disk drive 303 controls reading/writing of data from/to the disk 304 under the control of the CPU 301. The disk 304 stores data written under the control of the disk drive 303. Examples of the disk 304 include a magnetic disk, an optical disk, and the like.

The communication I/F 305 is connected to the network 210 through a communication line, and is connected to external computers (for example, the first information processing terminal 201, the second information processing terminal 202, and the operator terminal 203 illustrated in FIG. 2, and the like) via the network 210. Then, the communication I/F 305 manages an interface between the network 210 and the inside of the device, and controls input and output of data from an external computer. For example, a modem, a LAN adapter, or the like may be employed as the communication I/F 305.

The portable recording medium I/F 306 controls read/write of data from/to the portable recording medium 307 under the control of the CPU 301. The portable recording medium 307 stores data written under the control of the portable recording medium I/F 306. Examples of the portable recording medium 307 include a compact disc (CD)-ROM, a digital versatile disk (DVD), a universal serial bus (USB) memory, and the like.

Note that the information processing device 101 may include, for example, a solid state drive (SSD), an input device, a display, and the like in addition to the components described above. Furthermore, the information processing device 101 may not include, for example, the disk drive 303, the disk 304, the portable recording medium I/F 306, and the portable recording medium 307 among the components described above.

(Hardware Configuration Example of First and Second Information Processing Terminals 201 and 202)

Next, a hardware configuration example of the first and second information processing terminals 201 and 202 will be described. Here, the first and second information processing terminals 201 and 202 are described as “first information processing terminal 201 and the like”.

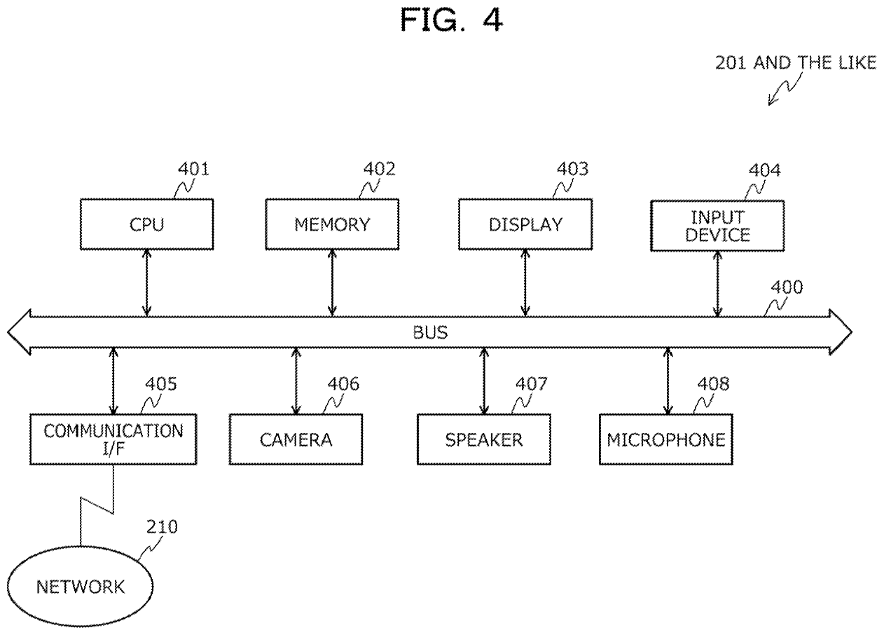

FIG. 4 is a block diagram illustrating a hardware configuration example of the information processing terminal 201. In FIG. 4, the first information processing terminal 201 and the like have a CPU 401, a memory 402, a display 403, an input device 404, a communication I/F 405, a camera 406, a speaker 407, and a microphone 408. Furthermore, the individual components are connected to each other via a bus 400.

Here, the CPU 401 performs overall control of the first information processing terminal 201 and the like. The CPU 401 may include a plurality of cores. The memory 402 is a storage unit including, for example, a ROM, a RAM, a flash ROM, and the like. For example, the flash ROM or the ROM stores various programs, while the RAM is used as a work area for the CPU 401. A program stored in the memory 402 is loaded to the CPU 401 to cause the CPU 401 to execute coded processing.

The display 403 is a display device that displays data such as a document, an image, or function information, as well as a cursor, icons, or tool boxes. For example, a liquid crystal display, an organic electroluminescence (EL) display, or the like may be adopted as the display 403.

The input device 404 has keys for inputting characters, numbers, various commands, and the like, and inputs data. The input device 404 may be a touch-panel input pad, a numeric keypad, or the like or may be a keyboard, a mouse, or the like.

The communication I/F 405 is connected to the network 210 through a communication line, and is connected to an external computer (for example, the information processing device 101 or the operator terminal 203) via the network 210. Then, the communication I/F 405 manages an interface between the network 210 and the inside of the local device, and controls input/output of data from an external device.

The camera 406 is a capture device that captures an image (still image or moving image) and outputs image data. The speaker 407 converts an electrical signal into a sound and outputs the sound. The microphone 408 receives a sound and converts the sound into an electrical signal.

Note that the first information processing terminal 201 and the like may include, for example, a hard disk drive (HDD), an SSD, a short-range wireless communication I/F, a portable recording medium I/F, a portable recording medium, a global positioning system (GPS) unit, and the like, in addition to the above-described components. Furthermore, the operator terminal 203 illustrated in FIG. 2 can also be implemented by a hardware configuration similar to the first information processing terminal 201 or the like.

(Stored Content of Script Table 240)

Next, stored content of the script table 240 included in the information processing device 101 will be described with reference to FIG. 5. The script table 240 is implemented by, for example, a storage device such as the memory 302 or the disk 304 illustrated in FIG. 3.

FIG. 5 is an explanatory diagram illustrating an example of the stored content of the script table 240. In FIG. 5, the script table 240 has fields for user attribute and script, and stores script management information 500-1 to 500-n (n is a natural number of 2 or larger) as a record by setting information in the respective field.

Here, the user attribute represents a characteristic of the user. Furthermore, in the case where the user has a companion, the user attribute may represent a characteristic of the companion. For example, the user attribute is classified by at least one or a combination of generation, gender, language, clothing, presence or absence of a companion, number of companions, presence or absence of a wheelchair, position information, meteorological information, or the like.

Examples of the user attribute include “having a companion (small child)”, “having a companion (adult and foreigner)”, “20s×female×having a companion (small child)”, “40s×male×having a companion (adult and foreigner)”, and the like. Note that the characteristics in the parentheses after “having a companion” represent the characteristics of the companion. Furthermore, as the user attribute, for example, an attribute intended for all of users such as “ALL” may be provided. Note that, here, an attribute ID (for example, UA1, UA2, . . . , or UAn) that identifies the user attribute is described.

The script is script information (scenario) that defines the flow of the conversation of the chatbot, and is prepared in association with the user attribute. Note that, here, a script ID (for example, SP1, SP2, . . . , or SPn) that identifies the script is described. For example, the script management information 500-1 indicates the script information SP1 corresponding to the user attribute UA1.

Note that what script information is associated with which user attribute is determined by analyzing the chat log stored in the chat log DB 230 illustrated in FIG. 2, for example. For example, the script information is created in consideration of changes in frequently used FAQs and services depending on differences in the characteristics of the users and companions. Furthermore, the script table 240 may be provided for each place (airport, station, store, commercial facility, or the like) that provides a service using two-way communication linked with a chatbot, for example.

(Specific Example of Script Information)

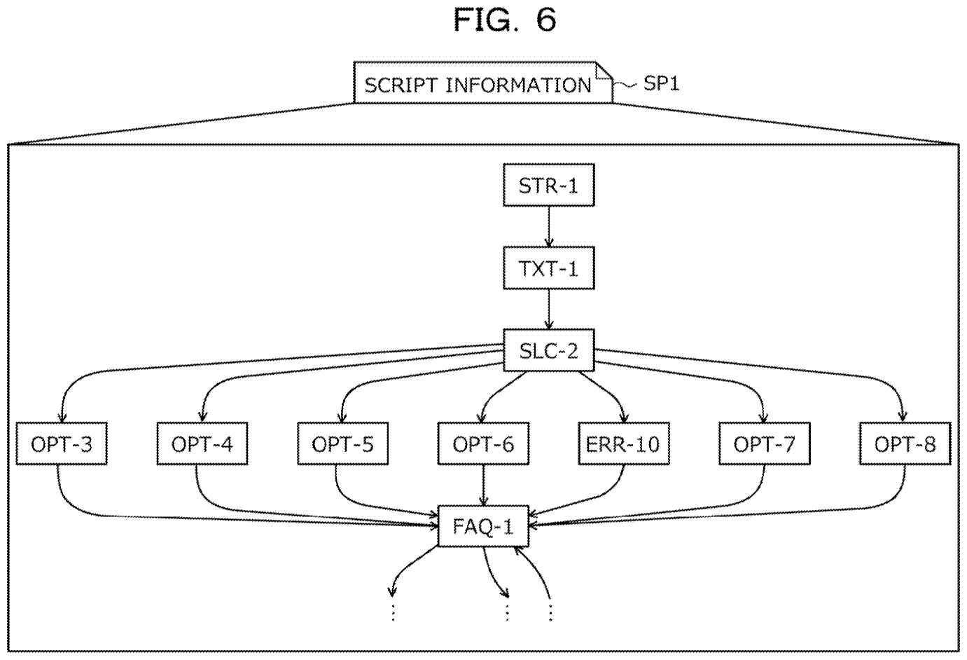

Here, a specific example of the script information will be described with reference to FIG. 6. Here, the script information SP1 corresponding to the user attribute UA1 will be described as an example.

FIG. 6 is an explanatory diagram illustrating a specific example of the script information. In FIG. 6, the script information SP1 is information (scenario) that defines the flow of the conversation flow of the chatbot. Note that FIG. 6 excerpts and displays a part of the script information SP1. Specifically, for example, the script information SP1 is information that defines chat talk processing.

The talk processing is processing for implementing an operation (behavior) of the chatbot. For example, the talk processing includes processing of speaking, processing of displaying options, processing of selecting an option according to a user operation, processing of performing a procedure according to the selected option or input information, processing of terminating the talk processing, and the like.

In the script information SP1, for example, STR-1 indicates the start of the talk processing. TXT-1 indicates the processing of speaking a message. SLC-2 indicates the processing of displaying options of OPT-3 to OPT-8. FAQ-1 indicates processing of searching for and displaying an FAQ according to the option. Note that ERR-10 indicates error processing. The search for an FAQ is performed using, for example, the FAQ master 220 illustrated in FIG. 2.

(Stored Content of Script Transfer Table 250)

Next, stored content of the script transfer table 250 included in the information processing device 101 will be described with reference to FIG. 7. The script transfer table 250 is implemented by, for example, a storage device such as the memory 302 or the disk 304 illustrated in FIG. 3.

FIG. 7 is an explanatory diagram illustrating an example of stored content of a script transfer table 250. In FIG. 7, the script transfer table 250 has fields for first script, transfer point, user attribute, and second script, and stores script transfer information (for example, script transfer information 700-1 to 700-6) as a record by setting information in the respective field.

Here, the first script is the script information of a transfer source. The user attribute represents a characteristic of the user, and is classified by, for example, a combination of generation, gender, language, clothing, position information, meteorological information, and the like. The user attribute may be “ALL”. The second script is the script information of a transfer destination, and is prepared in association with the user attribute.

For example, the script transfer information 700-1 indicates the script information SP1-1 of the transfer destination corresponding to the user attribute UA100 in association with the transfer point OPT-8 of the script information SP1 of the transfer source.

Note that the script transfer table 250 may store the second script in association with the transfer point of the first script. For example, the second script may be prepared in association with the transfer point of the first script without considering the user attribute.

(Functional Configuration Example of Information Processing device 101)

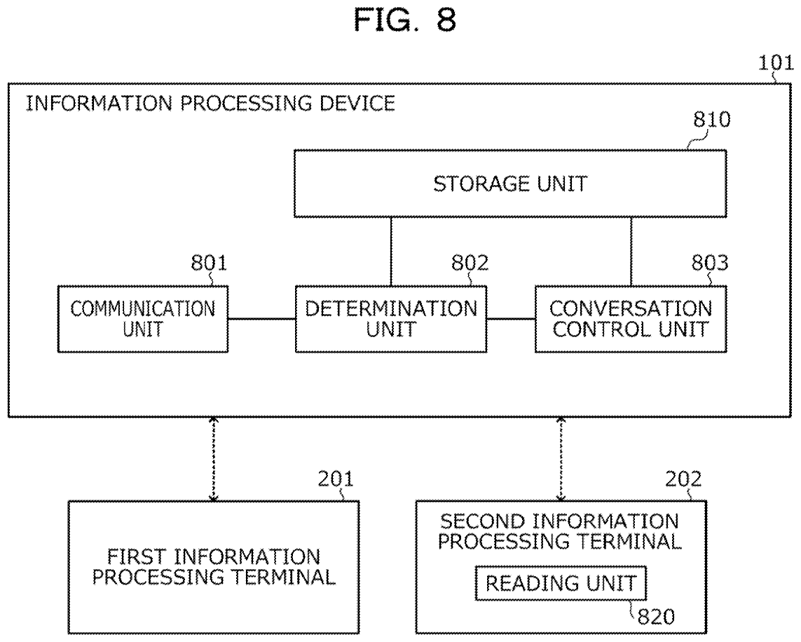

FIG. 8 is a block diagram illustrating a functional configuration example of the information processing device 101. In FIG. 8, the information processing device 101 includes a communication unit 801, a determination unit 802, a conversation control unit 803, and a storage unit 810. For example, the communication unit 801 to the conversation control unit 803 implement its functions by causing the CPU 301 to execute a program stored in the storage device such as the memory 302, the disk 304, or the portable recording medium 307 illustrated in FIG. 3, or by the communication I/F 305. A processing result of each functional unit is stored in, for example, the storage device such as the memory 302 or the disk 304. The storage unit 810 is implemented by the storage device such as the memory 302 or the disk 304, for example. Specifically, for example, the storage unit 810 stores the script table 240 illustrated in FIG. 5 and the script transfer table 250 illustrated in FIG. 7.

The communication unit 801 receives the chat start instruction from the first information processing terminal 201 and also receives the user information acquired by the first information processing terminal 201. Furthermore, the communication unit 801 may further receive the identification information corresponding to the first information processing terminal 201 as well as receiving the chat start instruction from the first information processing terminal 201.

Here, the user information is information regarding the user who uses the first information processing terminal 201. For example, the user information includes information that can specify the characteristics of the user. Furthermore, in the case where the user has a companion, the user information may include information that can specify the characteristics of the companion.

The characteristics of the user include, for example, age, generation, gender, language, clothing, presence or absence of a companion, presence or absence of a wheelchair, and the like. The characteristics of the companion include, for example, age, generation, gender, language, clothing, presence or absence of a wheelchair, and the like. Furthermore, the user information may include position information indicating the current position and meteorological information of the current position.

Specifically, for example, the first information processing terminal 201 may have the user information input by the user's operation input using the input device 404 (see FIG. 4). In this case, the first information processing terminal 201 transmits the input user information to the information processing device 101 together with, for example, the start instruction of the conversation with the chatbot.

Furthermore, in a case of detecting the user captured by the camera 406 (see FIG. 4) of the local terminal, the first information processing terminal 201 may acquire the user information in response to the user's operation input using the input device 404 (see FIG. 4). In this case, the information processing terminal 201 transmits the acquired user information to the information processing device 101 together with, for example, the start instruction of the conversation with the chatbot.

More specifically, for example, the first information processing terminal 201 may analyze image information (for example, a moving image) captured by the imaging device and acquire the user information such as the generation, gender, clothing, presence or absence of a wheelchair, or presence or absence of a companion of the user. In the case where the user has a companion, the first information processing terminal 201 may analyze the image information captured by the imaging device and acquire the user information such as the generation, gender, clothing, or presence or absence of a wheelchair of the companion.

The imaging device may be the camera 406 mounted on the first information processing terminal 201 or may be a camera (not illustrated) installed in association with the first information processing terminal 201. The camera (not illustrated) installed in association with the first information processing terminal 201 is installed at a position where the camera can capture the user who uses the first information processing terminal 201 at, for example, an airport, a store, or the like. Note that the camera (not illustrated) installed in association with the first information processing terminal 201 may be able to capture a person who is waiting for use of the first information processing terminal 201.

Furthermore, the first information processing terminal 201 may analyze sound information received by the microphone 408 (see FIG. 4) and acquire the user information such as the gender or language of the user or the companion. Furthermore, the first information processing terminal 201 may acquire the meteorological information such as temperature, humidity, or weather by using an environment sensor (not illustrated) or by inquiring an external server.

Furthermore, the first information processing terminal 201 may acquire the position information indicating the current position by a GPS unit (not illustrated). Note that, in a case where the first information processing terminal 201 is a stationary computer such as a digital board, the position information indicating an installation position of the first information processing terminal 201 may be stored in the memory 402 in advance.

Furthermore, the communication unit 801 may receive the image information captured by the camera 406 or the camera (not illustrated) installed in association with the first information processing terminal 201 as the user information. Furthermore, the communication unit 801 may receive the sound information received by the microphone 408 as the user information.

In this case, the information processing device 101 may acquire, for example, information indicating a characteristic of the user or the companion from the received image information or sound information. For example, the processing of analyzing the image information or the sound information may not be performed on the first information processing terminal 201 side but may be performed on the information processing device 101 side.

Note that any existing technique may be used as the technique of acquiring information representing the characteristic of the user or the companion from the image information and the sound information. For example, the first information processing terminal 201 or the information processing device 101 may extract the information such as the generation, gender, clothing, language, presence or absence of a wheelchair, or presence or absence of a companion from a characteristic amount of an image or a sound by a method based on machine learning such as deep learning.

The identification information corresponding to the first information processing terminal 201 is one of pieces of information to be used for determining the script information to be applied to the conversation of the chatbot in the first information processing terminal 201. For example, the identification information corresponding to the first information processing terminal 201 indicates that the first information processing terminal 201 is installed in a highly public place, a store, or a commercial facility. Furthermore, the identification information corresponding to the first information processing terminal 201 may be information that uniquely identifies the first information processing terminal 201.

The determination unit 802 determines the first script information to be applied to the conversation of the chatbot in the first information processing terminal 201. Specifically, for example, the determination unit 802 determines the first script information on the basis of the received identification information corresponding to the first information processing terminal 201.

As an example, the identification information corresponding to the first information processing terminal 201 is assumed to be information indicating that the first information processing terminal 201 is installed in the highly public place. In this case, the determination unit 802 determines, for example, the script information stored in advance for the terminal installed in the highly public place as the first script information.

Furthermore, the determination unit 802 may determine the first script information on the basis of the received user information by referring to the storage unit 810 that stores the script information corresponding to each of the plurality of user attributes, for example. For example, the determination unit 802 determines the first script information according to the characteristics of the user or the characteristics of the companion.

Furthermore, the determination unit 802 may determine the first script information on the basis of the received user information by referring to the storage unit 810 in a case where the identification information corresponding to the first information processing terminal 201 indicates that the first information processing terminal 201 is installed in a specific place. Examples of the specific place include a highly public place, store, commercial facility, and the like.

For example, the determination unit 802 determines the first script information according to the characteristics of the user or the characteristics of the companion only in the case where the first information processing terminal 201 is installed in a specific place. Note that, in the case where the first information processing terminal 201 is installed in a specific place, the determination unit 802 may determine the script information stored in advance for a terminal installed in a place other than the specific place as the first script information.

More specifically, for example, the determination unit 802 specifies the user attribute on the basis of the user information in response to the chat start instruction. Then, the determination unit 802 refers to the script table 240 and determines the script corresponding to the specified user attribute as the first script information.

For example, the user information is assumed to be “the presence or absence of a companion “presence” and the age of the companion “5 years old””. In this case, the determination unit 802 specifies the user attribute “having a companion (small child)” on the basis of the user information, for example. Then, the determination unit 802 refers to the script table 240 and determines the script corresponding to the specified user attribute “having a companion (small child)” as the first script information.

Furthermore, the attribute information of the user is assumed to be “the generation “20s”, the gender “female”, the presence or absence of a companion “presence”, the age of the companion “5 years old””. In this case, the determination unit 802 specifies the user attribute “20s×female×having a companion (small child)” on the basis of the user information, for example. Then, the determination unit 802 refers to the script table 240 and determines the script corresponding to the specified user attribute “20s×female×having a companion (small child)” as the first script information.

For example, the user information is assumed to be “the generation “40s”, the gender “male”, the presence or absence of a companion “presence”, the age of the companion “30s”, and the gender of the companion “female””. In this case, the determination unit 802 specifies the user attribute “40s×male×having a companion (adult and female)” on the basis of the user information, for example. Then, the determination unit 802 refers to the script table 240 and determines the script corresponding to the specified user attribute “40s×male×having a companion (adult and female)” as the first script information.

For example, the user information is assumed to be “the generation “40s”, the gender “male”, the presence or absence of a companion “presence”, the age of the companion “30s”, and the language of the companion “English””. In this case, the determination unit 802 specifies the user attribute “40s×male×having a companion (adult and foreigner)” on the basis of the user information, for example. Then, the determination unit 802 refers to the script table 240 and determines the script corresponding to the specified user attribute “40s×male×having a companion (adult and foreigner)” as the first script information.

Note that there are some cases where the script corresponding to the specified user attribute does not exist in the script table 240. In this case, the determination unit 802 may refer to the script table 240 and determine the script corresponding to the user attribute “ALL” as the first script information. Furthermore, the determination unit 802 may refer to the script table 240 and determine the script corresponding to at least one element of the user attributes as the first script information.

For example, it is assumed that there is no script corresponding to the user attribute “70s×female×having a companion (small child)”. In this case, the determination unit 802 may refer to, for example, the script table 240 and determine the script corresponding to the user attribute “having a companion (small child)” as the first script information.

The conversation control unit 803 starts the first conversation with the chatbot in the first information processing terminal 201 by using the determined first script information. Specifically, for example, the conversation control unit 803 uses the chatbot to speak, display options, and execute a procedure according to the selected option according to the first script information.

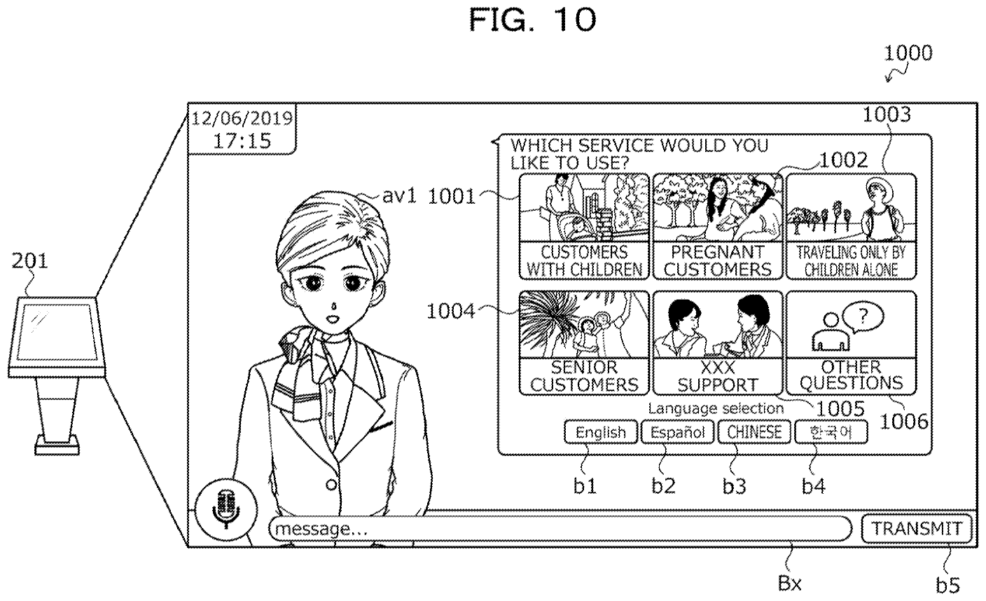

Note that the conversation history between the chatbot and the user in the first information processing terminal 201 (so-called chat log) is stored in, for example, the chat log DB 230 illustrated in FIG. 2. Furthermore, a screen example of a conversation screen displayed on the display 403 of the first information processing terminal 201 will be described below with reference to, for example, FIG. 10.

Furthermore, the conversation control unit 803 causes the first information processing terminal 201 to output the transfer guidance of the first conversation in a case where the conversation content received from the first information processing terminal 201 satisfies a predetermined condition after the start of the first conversation. Here, the conversation content includes, for example, the selected option and an input message in the first conversation.

The transfer guidance interrupts the conversation in the first information processing terminal 201 and encourages a subsequent conversation in the personal terminal (second information processing terminal 202). For example, the transfer guidance interrupts the first conversation on the first information processing terminal 201, and encourages the subsequent first conversation in the second information processing terminal 202 that the individual user owns, for example.

Furthermore, the transfer guidance is information from which the transfer information indicating transfer from the first conversation can be acquired by reading the transfer guidance. The transfer information includes information that identifies the first script information, for example, the script ID. Furthermore, the transfer information may include the information that specifies a point where the first conversation has been interrupted (transfer point), the conversation history of the first conversation, and the like.

The transfer point is represented by, for example, information for identifying the talk processing that has interrupted the first conversation, for example, a process name such as TXT-#, SLC-#, or OPT-#. The transfer point may be specified from the conversation history of the first conversation.

The transfer guidance is displayed on the display 403 of the first information processing terminal 201, for example, as a one-dimensional code or a two-dimensional code. An example of the one-dimensional code includes a bar code. An example of the two-dimensional code includes a QR code. At this time, the conversation control unit 803 may cause the first information processing terminal 201 to output a message such as “Please read the QR code” together with the QR code.

Furthermore, the transfer guidance may be output from a non-contact integrated circuit (IC) tag (not illustrated) of the first information processing terminal 201. At this time, the conversation control unit 803 may cause a non-contact IC tag portion of the first information processing terminal 201 to output a message such as “Please touch here”, for example. As the non-contact IC tag, a near field communication (NFC) tag can be used, for example.

Furthermore, the predetermined condition can be arbitrarily set. For example, the predetermined condition may be a condition that “the inquired content is related to the personal information”. The personal information is information by which an individual is specifiable, and is, for example, a name, date of birth, telephone number, an address, or the like. Furthermore, the predetermined condition may be a condition that “the inquired content is related to a specific store or service”. Note that information that specifies what kind of content (personal information, store, service, or the like) the inquired content is related to is described in, for example, the first script information.

Specifically, for example, the conversation control unit 803 analyzes the conversation content received from the first information processing terminal 201 on the basis of the first script information, and determines whether the conversation content satisfies the predetermined condition. Then, in a case of determining that the predetermined condition is satisfied, the conversation control unit 803 causes the first information processing terminal 201 to output the transfer guidance of the first conversation.

Note that which talk processing is used to output the transfer guidance of the first conversation may be preset in the first script information. For example, in the flow of the first conversation, it is set in advance so that the transfer guidance is output at timing when the predetermined condition is satisfied.

The second information processing terminal 202 acquires the transfer information indicating transfer from the first conversation by reading, by a reading unit 820, the transfer guidance from the first conversation output from the first information processing terminal 201. Specifically, for example, the second information processing terminal 202 acquires the transfer information by reading, by the reading unit 820, the QR code displayed on the display 403 of the first information processing terminal 201. Furthermore, the second information processing terminal 202 may acquire the transfer information by receiving, by the reading unit 820, the transfer guidance output from the non-contact IC tag of the first information processing terminal 201.

Furthermore, the second information processing terminal 202 may acquire the user information acquired by the first information processing terminal 201 together with the transfer information. Specifically, for example, the second information processing terminal 202 may acquire the user information together with the transfer information by reading, by the reading unit 820, the transfer guidance from the first conversation output from the first information processing terminal 201.

Furthermore, the second information processing terminal 202 may communicate with the first information processing terminal 201 by short-range wireless communication to acquire the user information. Furthermore, the second information processing terminal 202 may have the user information input by the user's operation input using the input device 404 of the local terminal, for example. Note that what kind of attribute information is input is determined in advance, for example.

The second information processing terminal 202 transmits the acquired transfer information to the information processing device 101 in response to the acquisition of the transfer information indicating the transfer from the first conversation. At this time, the second information processing terminal 202 may transmit the user information acquired by the local terminal to the information processing device 101 together with the transfer information.

The second information processing terminal 202 acquires the user information from, for example, the first information processing terminal 201 together with the transfer information. However, the second information processing terminal 202 may analyze the image information captured by the camera 406 of the local terminal or the sound information received by the microphone 408 (see FIG. 4) of the local terminal and acquire the user information. In this case, the second information processing terminal 202 does not need to acquire the user information that the first information processing terminal 201 acquires.

Furthermore, the second information processing terminal 202 may inquire of the user for permission to transmit the transfer information in transmitting the transfer information. In this case, the second information processing terminal 202 may transmit the user information acquired by the local terminal to the information processing device 101 together with the transfer information, for example, when the transmission permission is acquired.

The communication unit 801 receives the transfer information indicating the transfer from the first conversation from the second information processing terminal 202. Furthermore, the communication unit 801 may receive the user information acquired by the second information processing terminal 202 together with the transfer information.

The determination unit 802 determines the second script information to be applied to the conversation of the chatbot in the second information processing terminal 202 on the basis of the received transfer information. Specifically, for example, the determination unit 802 may determine the second script information on the basis of the transfer information by referring to the storage unit 810 that stores the script information that defines the flow of the conversation of the chatbot following the first conversation in association with the transfer point of the first script information.

Furthermore, the determination unit 802 may determine the second script information on the basis of the received transfer information and the user information. For example, it is assumed that the storage unit 810 stores the script information that defines the flow of the conversation of the chatbot following the first conversation corresponding to each of a plurality of user attributes in association with the transfer point of the first script information In this case, the determination unit 802 may determine the second script information on the basis of the transfer information and the user information with reference to the storage unit 810.

More specifically, for example, the determination unit 802 specifies the user attribute on the basis of the user information. Then, the determination unit 802 determines the second script information on the basis of the specified user attribute and the transfer information with reference to the script transfer table 250 as illustrated in FIG. 7.

For example, the user attribute specified from the user information is assumed to be “20s×female”. Furthermore, it is assumed that the transfer information includes the script ID “SP1” that identifies the first script information and the transfer point “OPT-8”. In this case, the determination unit 802 refers to the script transfer table 250 and determine the script corresponding to the first script “SP1”, the transfer point “OPT-8”, and the user attribute “20s×female” as the second script information.

Note that there are some cases where the script corresponding to the specified user attribute does not exist in the script transfer table 250. In this case, the determination unit 802 may refer to the script transfer table 250 and determine the script corresponding to the first script, the transfer point, and the user attribute “ALL” as the second script information.

The conversation control unit 803 starts the second conversation following the first conversation with the chatbot in the second information processing terminal 202 by using the determined second script information. Specifically, for example, the conversation control unit 803 uses the chatbot to speak, display options, and execute a procedure according to the selected option according to the second script.

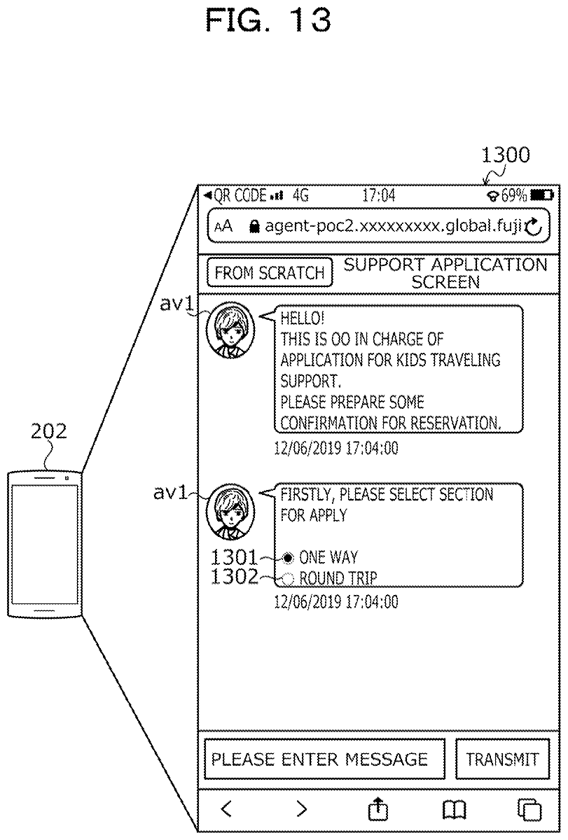

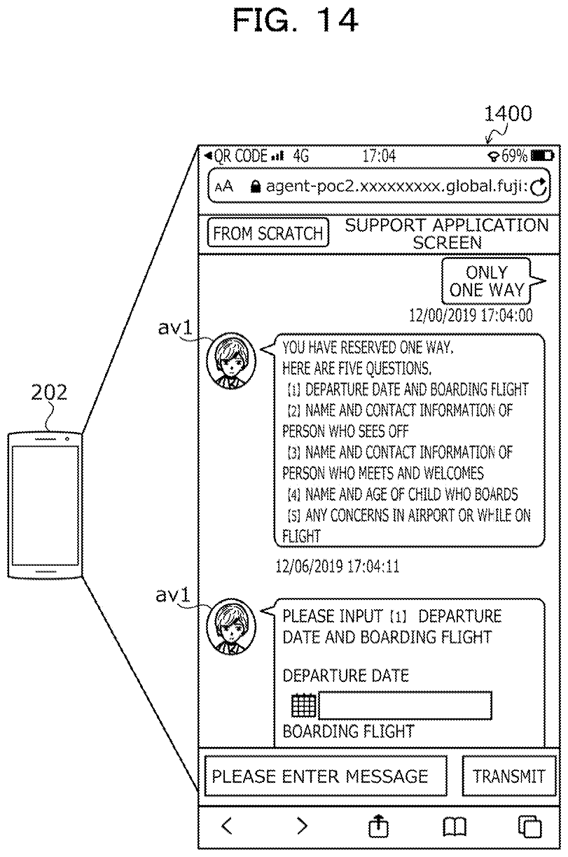

The conversation history between the chatbot and the user in the second information processing terminal 202 (so-called chat log) is stored in, for example, the chat log DB 230. Furthermore, a screen example of a conversation screen displayed on the display 403 of the second information processing terminal 202 will be described below with reference to FIGS. 13 and 14.

Furthermore, the conversation control unit 803 starts display of information different from the first conversation or processing different from the first conversation in the first information processing terminal 201 on the basis of the received user information acquired by the first information processing terminal 201. Here, the information different from the first conversation is information displayed to the companion, and is, for example, a message or an image having content different from the first conversation. Furthermore, the processing different from the first conversation is processing performed for the companion, and is, for example, processing of outputting information different from the first conversation or accepting input of information different from the first conversation.

Specifically, for example, the conversation control unit 803 determines whether the user information indicates that there is a companion. Here, in the case of indicating that the user has a companion, the conversation control unit 803 starts display of the information different from the first conversation or the processing different from the first conversation in the first information processing terminal 201 after starting the second conversation in the second information processing terminal 202, for example. On the other hand, in the case of indicating that the user has no companion, the conversation control unit 803 terminates the first conversation in the first information processing terminal 201 after starting the second conversation in the second information processing terminal 202, for example.

Furthermore, the user information that the first information processing terminal 201 has acquired is assumed to include the image information captured by the camera 406 mounted on the first information processing terminal 201 or the camera (not illustrated) installed in association with the first information processing terminal 201. In this case, the conversation control unit 803 may determine, for example, whether the image information included in the user information includes a person who satisfies a predetermined condition.

The person who satisfies a predetermined condition is, for example, a person who accompanies the user. More specifically, for example, a person who satisfies a predetermined condition is a child accompanying the user. As a child, for example, a small child aged about 2 to 6 or a young child aged about 7 to 15 is targeted. Then, the conversation control unit 803 starts display of information different from the first conversation or processing different from the first conversation in the first information processing terminal 201 in the case of determining that the image information includes a person who satisfies a predetermined condition.

On the other hand, the conversation control unit 803 does not start display of information different from the first conversation or processing different from the first conversation in the first information processing terminal 201 in the case of determining that the image information does not include a person who satisfies a predetermined condition. Then, the conversation control unit 803 terminates the first conversation in the first information processing terminal 201.

The information different from the first conversation is, for example, information for children. The information for children is, for example, digital content such as images, videos, and music created by small children and young children to see. The processing different from the first conversation is, for example, processing for children. The processing for children is, for example, quizzes, games, or the like created for use by small children and young children.

Furthermore, the conversation control unit 803 may determine the information different from the first conversation or the processing different from the first conversation according to the age or generation of the user's companion specified from the user information. For example, in the case where the companion's generation is “under 10 years old”, the conversation control unit 803 determines the information for children as the information different from the first conversation. Furthermore, the conversation control unit 803 determines the processing for children as the processing different from the first conversation.

For example, in the case where the companion's generation is “teens”, the conversation control unit 803 determines information for adolescents as the information different from the first conversation. Furthermore, the conversation control unit 803 determines processing for adolescents as the processing different from the first conversation. For example, in the case where the companion's generation is “20s”, the conversation control unit 803 determines information for adults as the information different from the first conversation. Furthermore, the conversation control unit 803 determines processing for adults as the processing different from the first conversation.

Furthermore, the conversation control unit 803 may determine the information different from the first conversation or the processing different from the first conversation according to the language used by the user's companion specified from the user information. For example, in the case where the companion's generation is “under 10 years old” and the language used by the companion is “English”, the conversation control unit 803 determines the information for children in English as the language used as the information different from the first conversation. Furthermore, the conversation control unit 803 determines the processing for children in English as the language used as the processing different from the first conversation.

Furthermore, the conversation control unit 803 may acquire waiting status information of the first information processing terminal 201. Then, the conversation control unit 803 may start display of information different from the first conversation or processing different from the first conversation in the first information processing terminal 201 on the basis of the received user information and the acquired waiting status information.

Here, the waiting status information of the first information processing terminal 201 is information that specifies a waiting status of a person waiting for use of the first information processing terminal 201. For example, the waiting status information is information that specifies the presence or absence or the number of people waiting in line for use of the first information processing terminal 201, a waiting time, and the like.

For example, it is assumed that the user information received from the first information processing terminal 201 includes the image information captured by the camera (not illustrated) installed in association with the first information processing terminal 201. This image information is obtained by capturing the person waiting for use of the first information processing terminal 201. In this case, the conversation control unit 803 may analyze, for example, the image information included in the user information, and acquire the waiting status information that specifies the presence or absence or the number of people waiting in line for use of the first information processing terminal 201 or the number of people.

Furthermore, there are some cases where a staff is allocated to each facility to support people who are unfamiliar with the operation of the first information processing terminal 201 and the like, and to explain a procedure method. There are some cases where the staff has an information processing terminal capable of inputting the waiting status information of the first information processing terminal 201. In this case, the conversation control unit 803 may acquire the waiting status information by receiving the waiting status information of the first information processing terminal 201 from the information processing terminal possessed by the staff.

Specifically, for example, the conversation control unit 803 determines whether a predetermined waiting status has occurred on the basis of the acquired waiting status information. The predetermined waiting status can be arbitrarily set, and is, for example, a status in which a predetermined number or more of waiting people or a waiting time of a predetermined time or longer has occurred.

Here, in the case where the predetermined waiting status has occurred, the conversation control unit 803 may not start both the display of information different from the first conversation and the processing different from the first conversation in the first information processing terminal 201 even if the user has a companion. On the other hand, in the case where the predetermined waiting status has not occurred, the conversation control unit 803 starts the display of information different from the first conversation or the processing different from the first conversation in the first information processing terminal 201 on the basis of the user information.

Furthermore, in the case where the predetermined waiting status has occurred, the conversation control unit 803 may determine digital content having a short playback time among a plurality of pieces of digital content as the information different from the first conversation. Alternatively, the conversation control unit 803 may determine a game having a short playing time among a plurality of games as the processing different from the first conversation.

Then, the conversation control unit 803 may acquire the waiting status information of the first information processing terminal 201 after starting the display of information different from the first conversation or the processing different from the first conversation in the first information processing terminal 201. Then, the conversation control unit 803 may terminate the display of information different from the first conversation or the processing different from the first conversation in the first information processing terminal 201 in the case of determining that the predetermined waiting status has occurred on the basis of the acquired waiting status information.

Note that, in the script information, processing of switching the conversation by the chatbot to the manned conversation when a specific condition is satisfied on the basis of the conversation history with the chatbot may be described. In this case, for example, the conversation control unit 803 switches the conversation by the chatbot to the manned conversation in the case where a specific condition is satisfied on the basis of the conversation history after starting the conversation with the chatbot according to the first script information.

More specifically, for example, the conversation control unit 803 may determine that the specific condition is satisfied when specific keywords are input. The specific keywords can be set arbitrarily. For example, the specific keywords may be complaint keywords such as “Let me talk to someone in charge” or “Let me talk to the manager”, or may be business keywords such as “luxury French” or “resort”.

Furthermore, the conversation control unit 803 may determine that the specific condition is satisfied in a case where, for example, when a specific option has been selected a plurality of times. The specific option is, for example, “no suitable option in here”, “No”, or the like, which is selected in a case where desired information is not able to be obtained. Then, in the case of determining that the specific condition is satisfied, the conversation control unit 803 connects the first information processing terminal 201 and the operator terminal 203 to switch the conversation by the chatbot to the manned conversation by the operator.

(Operation Example of Conversation Control System 200)

Next, an operation example of the conversation control system 200 will be described. Here, a case is assumed in which a user u1 (mother) uses a support service for children at the airport. The support service for children is one of services provided by airlines and supports children traveling alone. The user u1 (mother) has companions c1 and c2 (two children).

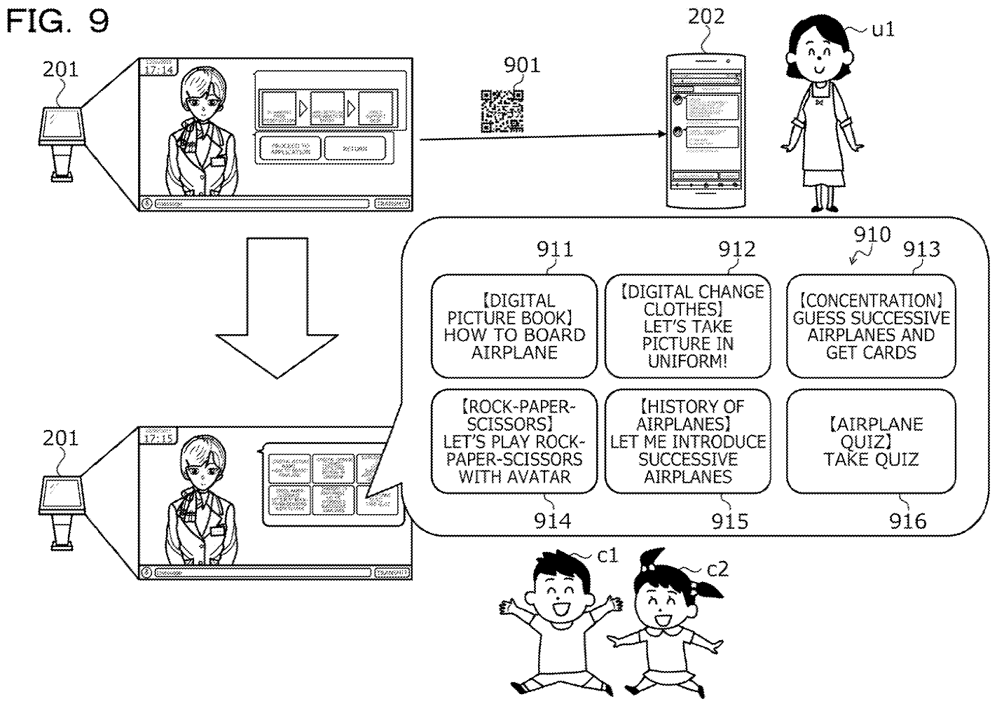

FIG. 9 is an explanatory diagram illustrating an operation example of the conversation control system 200. First, the user u1 (mother) starts the first conversation with the chatbot in the first information processing terminal 201. Specifically, for example, the information processing device 101 starts the first conversation with the chatbot in the first information processing terminal 201 in response to the chat start instruction. Note that, in FIG. 9, the information processing device 101 is not illustrated.

In the first information processing terminal 201, when it comes to a phase of applying for the support service for children, a QR code 901 is displayed because an input of the personal information is required. The QR code 901 is the transfer guidance for the first conversation. For example, the transfer guidance interrupts the conversation in the first information processing terminal 201 and encourages the user u1 (mother) to continue the conversation in the personal terminal (second information processing terminal 202).

The user u1 (mother) reads the QR code 901 displayed on the first information processing terminal 201 by using the second information processing terminal 202 to start the second conversation following the first conversation with the chatbot. Specifically, for example, when receiving the transfer information from the second information processing terminal 202, the information processing device 101 starts the second conversation following the first conversation with the chatbot in the second information processing terminal 202.

As a result, the user u1 (mother) can apply for the support service for children using the second information processing terminal 202 (see, for example, FIGS. 13 and 14 described below).

When the second conversation following the first conversation is started in the second information processing terminal 202, content for children 910 is displayed on the first information processing terminal 201. Specifically, for example, the information processing device 101 starts the processing different from the first conversation on the first information processing terminal 201 on the basis of the user information acquired by the first information processing terminal 201.

The content for children 910 is intended to attract the interest of the companions c1 and c2 (two children) who will wait while user u1 (mother) is operating on the second information processing terminal 202, and includes pieces of content 911 to 916.

When one of the pieces of content 911 to 916 is selected by the companion c1 and c2 (two children) in the first information processing terminal 201, information corresponding to the selected content is displayed or processed.

For example, when the content 911 is selected, a video about how to board an airplane is displayed in a picture book format so that even children can understand it. Furthermore, when the content 914 is selected, the children can play rock-paper-scissors with an avatar. Furthermore, when the content 916 is selected, the children can take a quiz about airplanes.

Thereby, the companions c1 and c2 (two children) can enjoy watching videos and playing games until the operation of the user u1 (mother) on the second information processing terminal 202 is completed. This prevents the children from getting bored and having a tantrum or going somewhere and getting lost while the parents are going through procedures.

(Screen Examples of Conversation Screen)

Next, screen examples of a conversation screen displayed on the display 403 of the first information processing terminal 201 or the second information processing terminal 202 will be described with reference to FIGS. 10 to 18.

Here, screen examples of the conversation screen will be described taking services provided by airlines as examples. Furthermore, it is assumed that the user is a “mother with a child”, and the user attribute specified from the user information acquired by the first information processing terminal 201 is “having a companion (small child)”.

FIG. 10 is an explanatory diagram (part 1) illustrating a screen example of the conversation screen displayed on the first information processing terminal 201. In FIG. 10, when a conversation screen 1000 is an example of the conversation screen displayed on the display 403 of the first information processing terminal 201 when the conversation with the chatbot is started using the first script information corresponding to the user attribute “having a companion (small child)”. In FIG. 10, an avatar av1 is a character representing an airport employee.

On the conversation screen 1000, selection buttons 1001 to 1005 respectively corresponding to a plurality of services are displayed in a conversation format. On the conversation screen 1000, a service to use can be selected by selecting one of the selection buttons 1001 to 1005 by the user's operation input using the input device 404 (see FIG. 4) of the first information processing terminal 201.

For example, selecting the selection button 1001 allows the user to have a conversation with the chatbot about a service for users with babies. Furthermore, selecting the selection button 1002 allows the user to have a conversation with the chatbot about a service for pregnant users. Furthermore, selecting the selection button 1003 allows the user to have a conversation with the chatbot about a support service for children.

Furthermore, selecting the selection button 1004 allows the user to have a conversation with the chatbot about a service for seniors. Furthermore, selecting the selection button 1005 allows the user to have a conversation with the chatbot about a service for priority guests. The priority guests are, for example, physically handicapped guests, sick or injured guests, and so on.

Furthermore, selecting the selection button 1006 on the conversation screen 1000 allows update of the content of the selection buttons to change available services. Furthermore, when selecting a language button b1, b2, b3, or b4 on the conversation screen 1000, the language to use can be switched. For example, when the user selects the language button b1, the language to use can be switched from Japanese to English.

Furthermore, a message can be input by selecting a box Bx, and the message input to the box Bx can be transmitted to the chatbot side (information processing device 101) by selecting a transmission button b5, on the conversation screen 1000.

In this way, according to the conversation screen 1000, the user can select a service to use from a plurality of services provided by the airline at the airport.

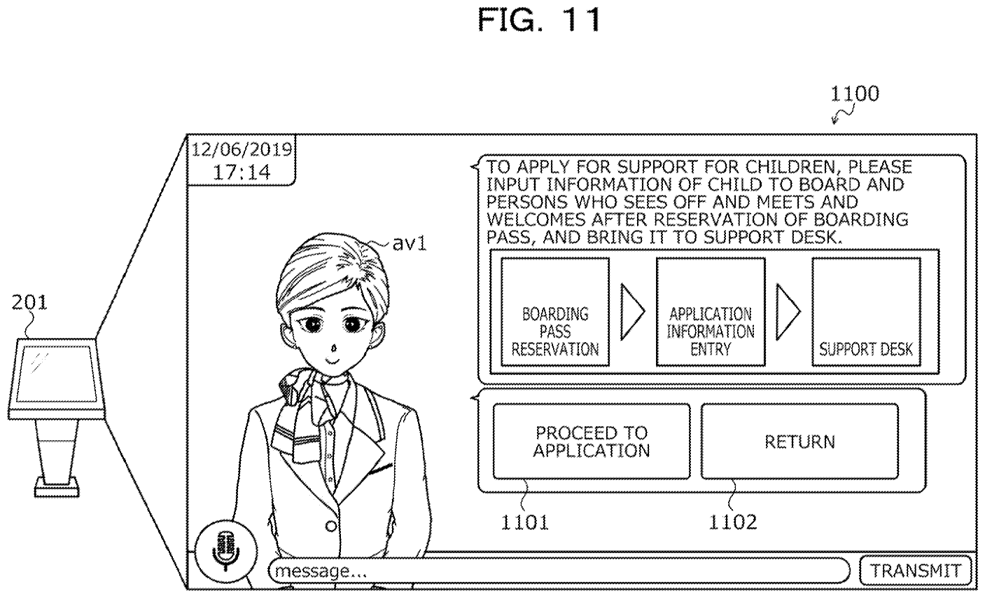

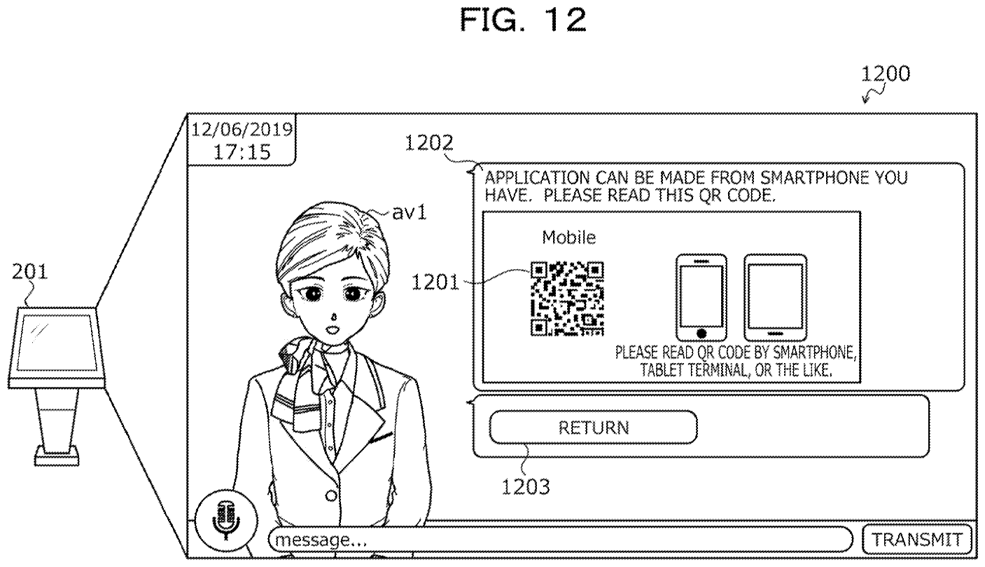

Next, a screen example of the conversation screen displayed on the first information processing terminal 201 in the case of using the support service for children will be described with reference to FIGS. 11 and 12.

FIG. 11 is an explanatory diagram (part 2) illustrating a screen example of the conversation screen displayed on the first information processing terminal 201. Furthermore, FIG. 12 is an explanatory diagram (part 3) illustrating a screen example of the conversation screen displayed on the first information processing terminal 201.

In FIG. 11, a conversation screen 1100 is an example of the conversation screen displayed on the display 403 of the first information processing terminal 201 when the selection button 1003 is selected on the conversation screen 1000 illustrated in FIG. 10. According to the conversation screen 1100, the user can check a procedure flow when applying for the support service for children.

Selecting a forward button 1101 on the conversation screen 1100 by the user's operation input allows the user to proceed to a conversation screen 1200 illustrated in FIG. 12. Furthermore, selecting a return button 1102 on the conversation screen 1100 allows the user to return to the conversation screen 1000 illustrated in FIG. 10.

In FIG. 12, the conversation screen 1200 is an example of the conversation screen displayed on the display 403 of the first information processing terminal 201 when the forward button 1101 is selected on the conversation screen 1100 illustrated in FIG. 11. The conversation screen 1200 is an operation screen for transferring the conversation (first conversation) with the chatbot in the first information processing terminal 201 to the personal terminal (second information processing terminal 202).

On the conversation screen 1200, a message 1202 is displayed in a conversation format together with a QR code 1201. The QR code 1201 is a transfer guidance regarding the conversation with the chatbot in the first information processing terminal 201. The message 1202 prompts the user to read the QR code 1201.

By the user reading the QR code 1201 using the second information processing terminal 202 such as a smartphone that the user owns himself/herself, the second information processing terminal 202 can take over the conversation with the chatbot in the first information processing terminal 201.

Note that selecting a return button 1203 on the conversation screen 1200 by the user's operation input allows the user to return to the conversation screen 1100 illustrated in FIG. 11.

Here, a screen example of the conversation screen displayed on the second information processing terminal 202 by reading the QR code 1201 displayed on the conversation screen 1200 illustrated in FIG. 12 will be described with reference to FIGS. 13 and 14.

FIG. 13 is an explanatory diagram (part 1) illustrating a screen example of the conversation screen displayed on the second information processing terminal 202. Furthermore, FIG. 14 is an explanatory diagram (part 2) illustrating a screen example of the conversation screen displayed on the second information processing terminal 202.

In FIG. 13, a conversation screen 1300 is an example of the operation screen for performing the second conversation following the first conversation with the chatbot in the first information processing terminal 201. On the conversation screen 1300, the user can select a section for applying for the support service for children.

Selecting a button 1301 on the conversation screen 1300 by the user's operation input allows the user to select “one way” as the section for applying for the support service for children. Furthermore, selecting a selection button 1302 allows the user to select “round trip” as the section for applying for the support service for children.

Here, a case where “one way” is selected as the section for applying for the support service for children is assumed. In this case, a conversation screen 1400 as illustrated in FIG. 14 is displayed.

In FIG. 14, the conversation screen 1400 is an example of the operation screen for inputting various types of information (including the personal information) required for using the support service for children. On the conversation screen 1400, the user can input information such as a departure date, a boarding flight, name and contact information of a person who sees off, name and contact information of a person who will meet and welcome, and a name and an age of the child.

Thereby, the user can apply for the support service for children using the second information processing terminal 202. For example, when the information input on the conversation screen 1400 is completed, a QR code is displayed on the second information processing terminal 202. This QR code is a two-dimensional code that records the various types of information input on the conversation screen 1400.

When the user presents this QR code at a counter reception in the airport, a support card for children with the QR code printed will be issued and the application for the support service for children will be completed. The support card for children is carried by the child traveling alone and is used to check the various types of information such as application content.

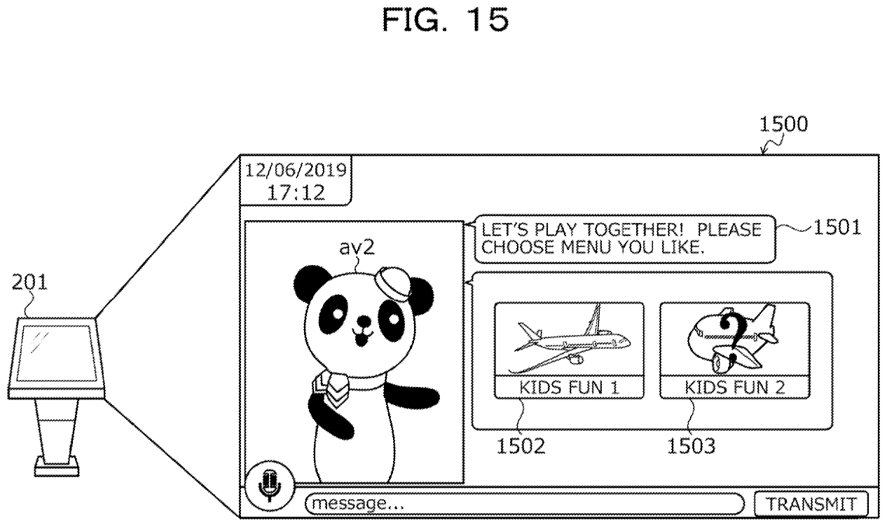

Next, a screen example of the conversation screen displayed on the first information processing terminal 201 in the case where the second conversation following the first conversation is started in the second information processing terminal 202 as a result of displaying the QR code 1201 (see FIG. 12) on the first information processing terminal 201 will be described with reference to FIG. 15.

FIG. 15 is an explanatory diagram (part 4) illustrating a screen example of the conversation screen displayed on the first information processing terminal 201. In FIG. 15, a conversation screen 1500 is an example of the conversation screen displayed on the display 403 of the first information processing terminal 201 after the conversation screen 1200 illustrated in FIG. 12 in the case where the user attribute is “having a companion (small child)”. In FIG. 15, an avatar av2 is a character representing an airport employee.

Information different from the first conversation is displayed on the conversation screen 1500. Specifically, on the conversation screen 1500, selection buttons 1502 and 1503 respectively corresponding to pieces of content for small children are displayed in a conversation format together with a message 1501. The message 1501 encourages selection of the content for small children.

On the conversation screen 1500, the content for small children to use can be selected by selecting either the selection button 1502 or 1503 by a companion (child)'s operation input using the input device 404 (see FIG. 4) of the first information processing terminal 201.

For example, selecting the selection button 1502 allows the child to have a conversation with the chatbot about content of Kids Fun 1. Furthermore, selecting the selection button 1503 allows the child to have a conversation with the chatbot about content of Kids Fun 2.

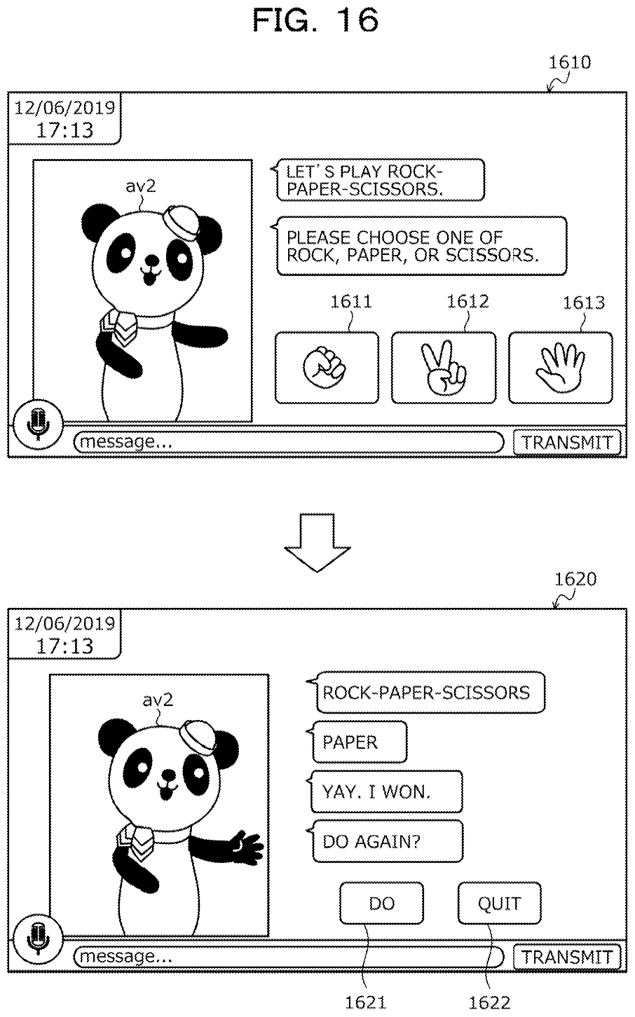

Here, a screen example of the conversation screen displayed on the first information processing terminal 201 in the case where the selection button 1502 is selected on the conversation screen 1500 will be described with reference to FIG. 16.

FIG. 16 is an explanatory diagram (part 5) illustrating a screen example of the conversation screen displayed on the first information processing terminal 201. In FIG. 16, a conversation screen 1610 is an operation screen regarding the content of Kids Fun 1. The content of Kids Fun 1 is content to play rock-paper-scissors with the avatar av2.

On the conversation screen 1610, the child can play rock-paper-scissors with the avatar av2 by selecting one of selection buttons 1611 to 1613 by the companion (child)'s input operation. For example, selecting the selection button 1611 allows the child to get “rock”. Selecting the selection button 1612 allows the child to get “scissors”. Selecting the selection button 1613 allows the child to get “paper”.

If the child loses to the rock-paper-scissors, an operation screen like a conversation screen 1620 will be displayed. On the conversation screen 1620, selecting the selection buttons 1621 by the companion (child)'s input operation allows the child to play rock-paper-scissors again with the avatar av2. Furthermore, on the conversation screen 1620, selecting the selection buttons 1622 by the companion (child)'s input operation allows the child to terminate the content of Kids Fun 1.

According to the conversation screens 1610 and 1620, the companion (child) can enjoy playing rock-paper-scissors with the avatar av2 while the user (mother) is going through the procedures on the second information processing terminal 202.

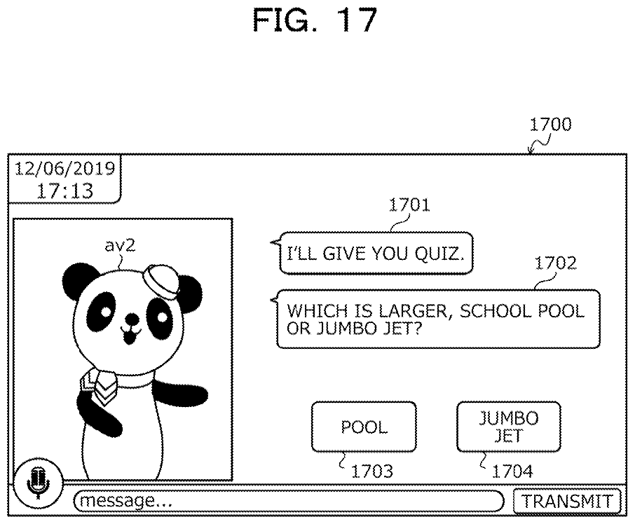

Next, a screen example of the conversation screen displayed on the first information processing terminal 201 in the case where the selection button 1503 is selected on the conversation screen 1500 will be described with reference to FIG. 17.

FIG. 17 is an explanatory diagram (part 6) illustrating a screen example of the conversation screen displayed on the first information processing terminal 201. In FIG. 17, a conversation screen 1700 is an operation screen related to content of Kids Fun 2. The content of Kids Fun 2 is content to take a quiz given by the avatar av2.

The conversation screen 1700 displays a quiz question 1702 in a conversation format along with a message 1701. The message 1701 encourages the child to answer the quiz. On the conversation screen 1700, the child can answer to the quiz by selecting either a selection button 1703 or 1704 by the companion (child)'s input operation.

For example, selecting the selection button 1703 allows the child to give “pool” as an answer to the quiz. Furthermore, selecting the selection button 1704 allows the child to give “jumbo jet” as an answer to the quiz.

According to the conversation screens 1700, the companion (child) can enjoy taking a quiz given by the avatar av2 while the user (mother) is going through the procedures on the second information processing terminal 202. Note that the quiz question 1702 illustrated in FIG. 17 is a relatively easy question for small children.

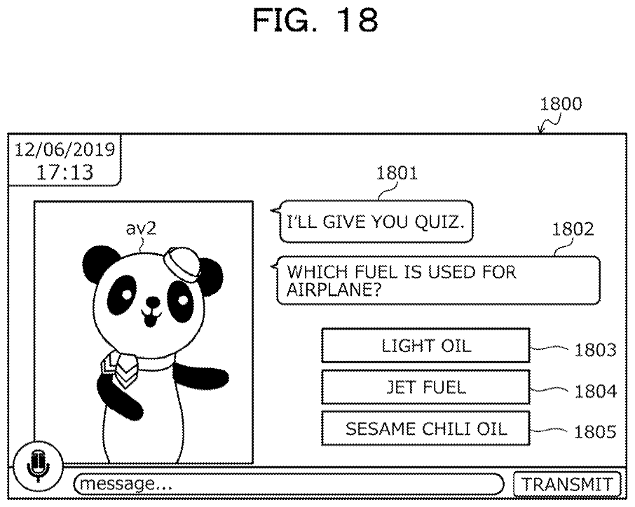

However, if the quiz question is too simple, the child might quickly get bored. For this reason, the quiz question may be determined according to the age and generation of the companion (child). Here, a screen example of the conversation screen displayed in a case where the age of the companion (child) is 10 to 12 years old will be described with reference to FIG. 18.

FIG. 18 is an explanatory diagram (part 7) illustrating a screen example of the conversation screen displayed on the first information processing terminal 201. In FIG. 18, a conversation screen 1800 is an operation screen regarding content of Kids Fun 2. The content of Kids Fun 2 is content to take a quiz given by the avatar av2.

The conversation screen 1800 displays a quiz question 1802 in a conversation format along with a message 1801. On the conversation screen 1800, the child can answer to the quiz by selecting one of selection buttons 1803 to 1805 by the companion (child)'s input operation.

For example, selecting the selection button 1803 allows the child to give “light oil” as an answer to the quiz. Furthermore, selecting the selection button 1804 allows the child to give “jet fuel” as an answer to the quiz. Furthermore, selecting the selection button 1805 allows the child to give “sesame chili oil” as an answer to the quiz.

The quiz question 1802 is for upper grades of elementary school, and difficulty level is higher than that of the quiz question 1702 illustrated in FIG. 17. In this way, by controlling a difficulty level of the quiz according to the age and generation of the companion (child), the children can be prevented from being get bored soon due to too easy quiz questions or too difficult quiz questions.

(Conversation Control Processing Procedure of Information Processing Device 101)

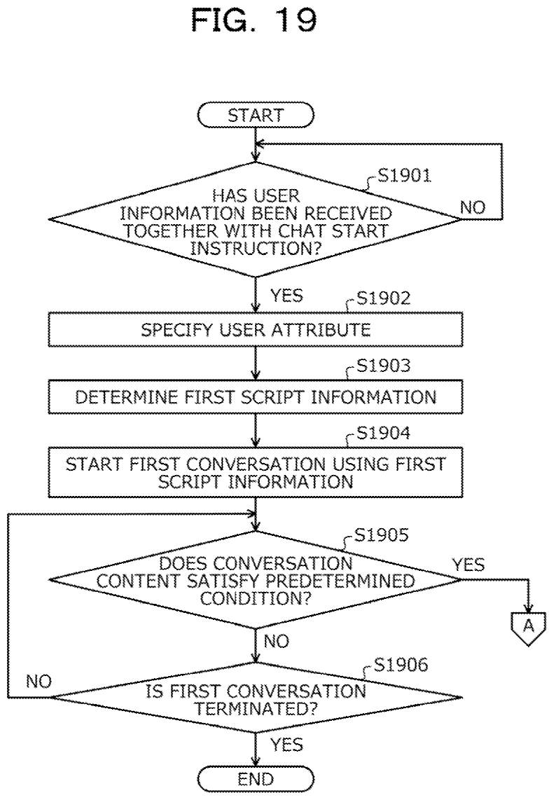

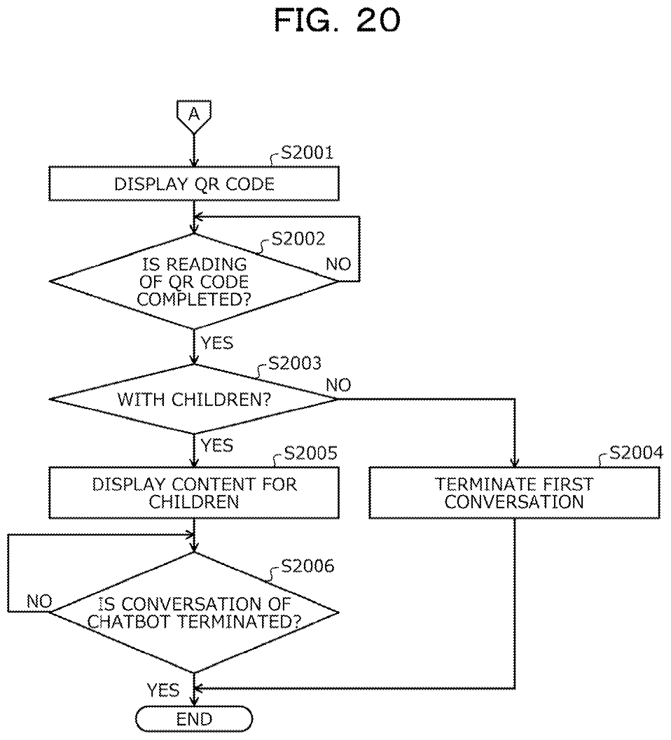

Next, a conversation control processing procedure of the information processing device 101 will be described with reference to FIGS. 19 to 21. First, the first conversation control processing procedure for controlling the conversation of the chatbot in the first information processing terminal 201 will be described with reference to FIGS. 19 and 20.

FIGS. 19 and 20 are flowcharts illustrating an example of a first conversation control processing procedure of the information processing device 101. In the flowchart of FIG. 19, first, the information processing device 101 determines whether the user information acquired by the first information processing terminal 201 has been received from the first information processing terminal 201 together with the chat start instruction (step S1901).

Here, the information processing device 101 waits for receiving the user information together with the chat start instruction (step S1901: No). Then, in the case of receiving the user information together with the chat start instruction (step S1901: Yes), the information processing device 101 specifies the user attribute on the basis of the received user information (step S1902).

Next, the information processing device 101 refers to the script table 240 and determines the script corresponding to the specified user attribute as the first script information (step S1903). The first script information is script information applied to the conversation of the chatbot in the first information processing terminal 201.

Then, the information processing device 101 starts the first conversation with the chatbot in the first information processing terminal 201 using the determined first script information (step S1904). Next, the information processing device 101 determines whether the conversation content received from the first information processing terminal 201 satisfies a predetermined condition (step S1905).

For example, the information processing device 101 determines that the conversation content satisfies a predetermined condition in a case where it is determined from the conversation content received from the first information processing terminal 201 that the content to be inquired from the next time onward is related to the personal information. Furthermore, the information processing device 101 may determine that the conversation content satisfies a predetermined condition in a case where it is determined from the conversation content received from the first information processing terminal 201 that the content to be inquired from the next time onward is related to a specific store or service.

Here, in the case where the conversation content does not satisfy the predetermined condition (step S1905: No), the information processing device 101 determines whether to terminate the first conversation (step S1906). The first conversation is terminated according to the first script information or in response to a user's forced termination operation, for example.

Here, in the case of not terminating the first conversation (step S1906: No), the information processing device 101 returns to step S1905. On the other hand, in the case of terminating the first conversation (step S1906: Yes), the information processing device 101 terminates the series of processing by the present flowchart.

Furthermore, in the case where the conversation content satisfies the predetermined condition in step S1905 (step S1905: Yes), the information processing device 101 proceeds to step S2001 illustrated in FIG. 20.

In the flowchart of FIG. 20, first, the information processing device 101 displays the transfer guidance of the first conversation as a QR code on the display 403 of the first information processing terminal 201 (step S2001). Then, the information processing device 101 determines whether reading of the QR code has been completed (step S2002).

Here, the information processing device 101 waits for the reading of the QR code to be completed (step S2002: No). Note that whether the reading of the QR code has been completed is determined by, for example, whether the second conversation following the first conversation has been started in the second information processing terminal 202.

Then, when the reading of the QR code has been completed (step S2002: Yes), the information processing device 101 refers to the specified user attribute and determines whether the user is accompanied by a child (step S2003). As a target child, for example, a small child aged about 2 to 6 or a young child aged about 7 to 15 is targeted.

Here, in the case where the user is not accompanied by a child (step S2003: No), the information processing device 101 terminates the first conversation with the chatbot in the first information processing terminal 201 (step S2004) and terminates the series of processing by the present flowchart.

On the other hand, in the case where the user is accompanied by a child (step S2003: Yes), the information processing device 101 displays the content for children on the first information processing terminal 201 (step S2005). The content for children may be determined according to the age and generation of the child.

Then, the information processing device 101 determines whether to terminate the conversation with the chatbot in the first information processing terminal 201 (step S2006). The conversation with the chatbot is terminated according to the first script information or in response to the user's forced termination operation, for example.

Here, in the case of not terminating the conversation with the chatbot (step S2006: No), the information processing device 101 returns to step S2006. On the other hand, in the case of terminating the conversation with the chatbot (step S2006: Yes), the information processing device 101 terminates the series of processing by the present flowchart.

Thereby, it is possible to control the flow of the conversation of the chatbot in the first information processing terminal 201 according to the characteristics of the user or the companion who uses the first information processing terminal 201. Furthermore, it is possible to interrupt the conversation in the first information processing terminal 201 (open chat) and encourage a subsequent conversation in the second information processing terminal 202 (closed chat) at the timing such as occurrence of an inquiry related to the personal information.

Furthermore, in the case where the user is accompanied by a child, the content for children is displayed on the first information processing terminal 201 to entertain the child while the user is handling a subsequent chat on the second information processing terminal 202.

Note that, in step S1901, the information processing device 101 may further receive the identification information corresponding to the first information processing terminal 201 as well as receiving the chat start instruction from the first information processing terminal 201. In this case, in step S1903, the information processing device 101 may further determine the first script information on the basis of the identification information corresponding to the first information processing terminal 201.

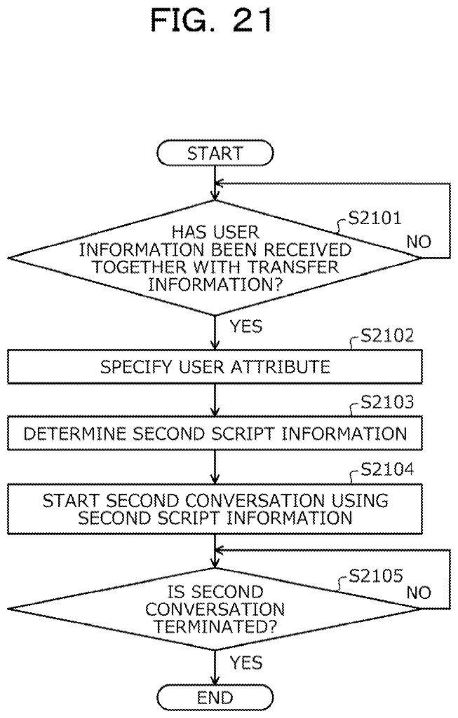

Next, a second conversation control processing procedure for controlling the conversation of the chatbot in the second information processing terminal 202 will be described with reference to FIG. 21.

FIG. 21 is a flowchart illustrating an example of the second conversation control processing procedure of the information processing device 101. In the flowchart of FIG. 21, first, the information processing device 101 determines whether the user information has been received from the second information processing terminal 202 together with the transfer information indicating the transfer from the first conversation (step S2101). The user information is, for example, the user information acquired by the first information processing terminal 201.

Here, the information processing device 101 waits for receiving the user information together with the transfer information (step S2101: No). Then, in the case of receiving the user information together with the transfer information (step S2101: Yes), the information processing device 101 specifies the user attribute on the basis of the received user information (step S2102).

Next, the information processing device 101 refers to the script transfer table 250, and determines the second script information to be applied to the conversation of the chatbot in the second information processing terminal 202 on the basis of the specified user attribute processing device and the transfer information (step S2103). Then, the information processing device 101 starts the second conversation following the first conversation with the chatbot in the second information processing terminal 202 using the determined second script information (step S2104).

Next, the information processing device 101 determines whether to terminate the second conversation with the chatbot in the second information processing terminal 202 (step S2105). The second conversation with the chatbot is terminated according to the second script information or in response to the user's forced termination operation, for example.

Here, the information processing device 101 waits for the termination of the second conversation (step S2105: No). Then, in the case of terminating the second conversation (step S2105: Yes), the information processing device 101 terminates the series of processing by the present flowchart.

Thereby, it is possible to transfer the conversation in the open chat that has been interrupted at the timing such as occurrence of an inquiry related to the personal information to the conversation in the closed chat.

As described above, according to the information processing device 101 of the embodiment, it is possible to receive the chat start instruction from the first information processing terminal 201 and receive the user information acquired by the first information processing terminal 201, and start the first conversation with the chatbot in the first information processing terminal 201 in response to the chat start instruction.

Thereby, it is possible to start the first conversation with the chatbot in the first information processing terminal 201 in response to the chat start instruction from the first information processing terminal 201.

Furthermore, according to the information processing device 101, it is possible to start the second conversation following the first conversation with the chatbot in the second information processing terminal 202 on the basis of the transfer information in the case of receiving the transfer information indicating the transfer from the first conversation from the second information processing terminal 202.

Thereby, it is possible to transfer the conversation with the chatbot from the first information processing terminal 201 installed in the highly public place and used by an unspecified number of people to, for example, the second information processing terminal 202 that the individual user owns. For example, in the case of inputting the personal information, the personal information can be prevented from being stolen by a third party, by the transfer of the conversation with the chatbot from the first information processing terminal 201 to the second information processing terminal 202. Furthermore, in the case where a troublesome procedure is required to use the service, it is possible to allow the user to go through the procedures using the familiar terminal, by the transfer of the conversation with the chatbot from the first information processing terminal 201 to the second information processing terminal 202.

Furthermore, according to the information processing device 101, it is possible to start display of information different from the first conversation or processing different from the first conversation in the first information processing terminal 201 on the basis of the received user information. Specifically, for example, in the case of determining that the user has a companion on the basis of the received user information, the information processing device 101 starts display of information different from the first conversation or processing different from the first conversation in the first information processing terminal 201, after starting the second conversation in the second information processing terminal 202.

Thereby, in the case where the user has the companion, it is possible to entertain the companion by displaying or processing information that attracts the companion's interest while the user is handling a subsequent chat on the second information processing terminal 202.

Furthermore, according to the information processing device 101, it is possible to receive the user information including the image information captured by the imaging device as well as the chat start instruction from the first information processing terminal 201. The imaging device is the camera 406 mounted on the first information processing terminal 201 or the camera (not illustrated) installed in association with the first information processing terminal 201. Then, according to the information processing device 101, it is possible to start display of information different from the first conversation or processing different from the first conversation in the first information processing terminal 201 in the case of determining that the image information included in the received user information includes a person who satisfies a predetermined condition. The person who satisfies a predetermined condition is, for example, a child who accompanies the user.

Thereby, it is possible to determine the presence or absence of a person who accompanies the user, for example, a child, from the image information captured by the camera 406 mounted on the first information processing terminal 201 or the camera (not illustrated) installed in association with the first information processing terminal 201.

Furthermore, according to the information processing device 101, it is possible to start display of the information for children or processing for children in the first information processing terminal 201. The children are, for example, small children aged about 2 to 6 or young children aged about 7 to 15.

Thereby, in the case where a child accompanies the user, it is possible to entertain the child by displaying or processing information while the user is handling a subsequent chat in the second information processing terminal 202.

Furthermore, according to the information processing device 101, it is possible to acquire the waiting status information of the first information processing terminal 201. The waiting status information of the first information processing terminal 201 is information that specifies the waiting status of a person waiting for use of the first information processing terminal 201. Then, according to the information processing device 101, it is possible to start display of information different from the first conversation or processing different from the first conversation in the first information processing terminal 201 on the basis of the received user information and the acquired waiting status information.

Thereby, it is possible to start display of information different from the first conversation or processing different from the first conversation in the first information processing terminal 201 in consideration of the waiting status of the person waiting for the use of the first information processing terminal 201.

Furthermore, according to the information processing device 101, it is possible not to start both the display of information different from the first conversation and the processing different from the first conversation in the first information processing terminal 201 in the case of determining that a predetermined waiting status has occurred on the basis of the waiting status information of the first information processing terminal 201.

Thereby, when the number of people waiting in line for use of the first information processing terminal 201 or the waiting time is large, it is possible not to perform the display or processing of information for companions even if there is the companion and prevent the first information processing terminal 201 from being used by some people for a long time.

Furthermore, according to the information processing device 101, it is possible to determine the first script information to be applied to the conversation of the chatbot in the first information processing terminal 201 on the basis of the received user information, and start the first conversation with the chatbot in the first information processing terminal 201 using the determined first script information.

Thereby, it is possible to change the flow of the first conversation of the chatbot in the first information processing terminal 201 according to the script information determined according to the characteristics of the user or the characteristics of the companion who uses the first information processing terminal 201.

Furthermore, according to the information processing device 101, it is possible to further receive the identification information corresponding to the first information processing terminal 201 as well as receiving the chat start instruction from the first information processing terminal 201. Then, according to the information processing device 101, it is possible to determine the first script information to be applied to the conversation of the chatbot in the first information processing terminal 201 on the basis of the received identification information.

Thereby, it is possible to change the flow of the first conversation of the chatbot in the first information processing terminal 201 according to the script information determined according to the place (for example, the highly public place) where the first information processing terminal 201 is provided.

Furthermore, according to the information processing device 101, it is possible to determine the second script information to be applied to the conversation of the chatbot in the second information processing terminal 202 on the basis of the received transfer information, and start the second conversation following the first conversation with the chatbot in the second information processing terminal 202 using the determined second script information.

Thereby, it is possible to change the flow of the second conversation following the first conversation with the chatbot in the second information processing terminal 202 according to the script information determined according to the transfer information indicating transfer from the first conversation.

Furthermore, according to the information processing device 101, it is possible determine the information different from the first conversation or the processing different from the first conversation according to the age or generation of the user's companion specified from the received user information.

Thereby, it is possible to determine the content provided for companions by the first information processing terminal 201 according to the age or generation of the companion. Therefore, it is possible to display the information preferred by the companion or perform the processing preferred by the companion to entertain the companion in the first information processing terminal 201 while the user is handling a subsequent chat on the second information processing terminal 202.

Furthermore, according to the information processing device 101, it is possible determine the information different from the first conversation or the processing different from the first conversation according to the language used by the user's companion specified from the received user information.

Thereby, it is possible to determine the content provided for companions by the first information processing terminal 201 according to the language used by the companion.

Furthermore, according to the information processing device 101, it is possible to acquire the waiting status information of the first information processing terminal 201 after starting the display of information different from the first conversation or the processing different from the first conversation in the first information processing terminal 201. Then, according to the information processing device 101, it is possible terminate the display of information different from the first conversation or the processing different from the first conversation in the first information processing terminal 201 in the case of determining that the predetermined waiting status has occurred on the basis of the acquired waiting status information.

Thereby, when the number of people waiting in line for use of the first information processing terminal 201 or the waiting time is large, it is possible to terminate the display or processing of information for companions and prevent the first information processing terminal 201 from being used by some people for a long time. For example, even if the subsequent chat handling in the second information processing terminal 202 has not been completed, the display or processing of information for companions in the first information processing terminal 201 is terminated.

Furthermore, according to the information processing device 101, it is possible to cause the first information processing terminal 201 to output the transfer guidance of the first conversation in the case where the conversation content received from the first information processing terminal 201 satisfies a predetermined condition after the start of the first conversation.

Thereby, it is possible to interrupt the conversation with the chatbot in the first information processing terminal 201 and encourage the subsequent conversation in the second information processing terminal 202 at the timing when the conversation content satisfies the predetermined condition. Furthermore, the second information processing terminal 202 becomes able to acquire the transfer information indicating transfer from the first conversation by reading the transfer guidance output from the first information processing terminal 201.

Furthermore, according to the information processing device 101, it is possible to cause the first information processing terminal 201 to display the QR code as the transfer guidance of the first conversation.

Thereby, it is possible to cause the second information processing terminal 202 to acquire the transfer information indicating transfer from the first conversation by the simple operation of reading the QR code by the second information processing terminal 202.

Furthermore, according to the information processing device 101, it is possible to cause the first information processing terminal 201 to output the transfer guidance in the case of determining that the inquired content is related to the personal information from the conversation content received from the first information processing terminal 201.

Thereby, it is possible to transfer the conversation with the chatbot from the first information processing terminal 201 to the second information processing terminal 202 at the timing when input of the personal information occurs to prevent the personal information from being seen by others or being leaked.

From the above, according to the information processing device 101 and the conversation control system 200 of the embodiment, it is possible to entertain the companion and smoothly use the service while the user handles the subsequent chat in the second information processing terminal 202 after transferring the conversation with the chatbot from the first information processing terminal 201 to the second information processing terminal 202. Furthermore, it is possible to improve use efficiency of the first information processing terminal 201 by achieving smooth use of the service using the chatbot.

For example, it is possible to allow the user (parent) with children to comfortably perform operation such as data input by entertaining the children and preventing the children from making noise or getting lost while the user (parent) is going through the procedures. Furthermore, it is possible to allow the user (coordinator) with foreign tourists to comfortably perform operation such as data input by entertaining the foreign tourists and preventing the foreign tourists from wasting their time while the user (coordinator) is going through the procedures.

Note that the conversation control method described in the present embodiments may be implemented by a computer such as a personal computer or a workstation executing a prepared program. The present conversation control program is recorded on a computer-readable recording medium such as a hard disk, flexible disk, compact disk read only memory (CD-ROM), digital versatile disc (DVD), or USB memory, and is read from the recording medium to be executed by the computer. Furthermore, the present conversation control program may be distributed via a network such as the Internet.

Furthermore, the information processing device 101 described in the present embodiment may also be implemented by a special-purpose integrated circuit (IC) such as a standard cell or a structured application specific integrated circuit (ASIC) or a programmable logic device (PLD) such as a field-programmable gate array (FPGA).

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a conversation control program for causing a computer to execute processing comprising:
receiving a chat start instruction from a first information processing terminal and receiving user information acquired by the first information processing terminal;
starting a first conversation with a chatbot in the first information processing terminal in response to the chat start instruction;
in a case of receiving transfer information that indicates transfer from the first conversation from a second information processing terminal, starting a second conversation that follows the first conversation with the chatbot in the second information processing terminal on the basis of the transfer information; and
starting display of different information from the first conversation or different processing from the first conversation in the first information processing terminal on the basis of the received user information.

2. The non-transitory computer-readable recording medium according to claim 1, wherein
the user information includes an imaging device mounted on the first information processing terminal or image information captured by the imaging device installed in association with the first information processing terminal, and
the processing of starting the display of different information or the different processing includes
starting the display of different information or the different processing in the first information processing terminal in a case of determining that the image information includes a person that satisfies a predetermined condition.

3. The non-transitory computer-readable recording medium according to claim 1, wherein the display of different information or the different processing is display of information for children or processing for children.

4. The non-transitory computer-readable recording medium according to claim 1, for causing the computer to execute processing comprising:
acquiring information that specifies a waiting status of a person who waits for use of the first information processing terminal, wherein
the processing of starting the display of different information or the different processing includes
starting the display of different information or the different processing in the first information processing terminal on the basis of the received user information and the acquired information that specifies a waiting status.

5. The non-transitory computer-readable recording medium according to claim 1, wherein
the processing of starting the first conversation includes
determining first script information to be applied to a conversation of a chatbot in the first information processing terminal on the basis of the received user information, and starting the first conversation with the chatbot in the first information processing terminal by using the determined first script information, and
the processing of starting the second conversation includes
determining second script information to be applied to a conversation of a chatbot in the second information processing terminal on the basis of the received transfer information, and starting the second conversation that follows the first conversation with the chatbot in the second information processing terminal by using the determined second script information.

6. The non-transitory computer-readable recording medium according to claim 1, wherein
the processing of receiving includes
receiving the chat start instruction and further receiving identification information that corresponds to the first information processing terminal,
the processing of starting the first conversation includes
determining first script information to be applied to a conversation of a chatbot in the first information processing terminal on the basis of the received identification information, and starting the first conversation with the chatbot in the first information processing terminal by using the determined first script information, and
the processing of starting the second conversation includes
determining second script information to be applied to a conversation of a chatbot in the second information processing terminal on the basis of the received transfer information, and starting the second conversation that follows the first conversation with the chatbot in the second information processing terminal by using the determined second script information.

7. The non-transitory computer-readable recording medium according to claim 4, wherein
the processing of starting the display of different information or the different processing includes
not starting both the display of different information and the different processing in the first information processing terminal in a case of determining that a predetermined waiting status has occurred on the basis of the information that specifies the waiting status.

8. The non-transitory computer-readable recording medium according to claim 1, wherein the different information or the different processing is determined according to age or generation of a companion of a user specified from the user information.

9. The non-transitory computer-readable recording medium according to claim 1, for causing the computer to execute processing comprising:
causing the first information processing terminal to output a transfer guidance of the first conversation in a case where conversation content received from the first information processing terminal satisfies a predetermined condition after starting the first conversation, wherein
the transfer information is acquired on the basis of the transfer guidance read by the second information processing terminal.

10. The non-transitory computer-readable recording medium according to claim 9, wherein the transfer guidance is displayed on the first information processing terminal as a quick response (QR) code.

11. The non-transitory computer-readable recording medium according to claim 9, wherein
the processing of outputting includes
causing the first information processing terminal to output the transfer guidance in a case of determining that content inquired from the conversation content is related to personal information.

12. A conversation control method comprising:
receiving, by a computer, a chat start instruction from a first information processing terminal and receiving user information acquired by the first information processing terminal;
starting a first conversation with a chatbot in the first information processing terminal in response to the chat start instruction;
in a case of receiving transfer information that indicates transfer from the first conversation from a second information processing terminal, starting a second conversation that follows the first conversation with the chatbot in the second information processing terminal on the basis of the transfer information; and
starting display of different information from the first conversation or different processing from the first conversation in the first information processing terminal on the basis of the received user information.

13. An information processing device comprising:
a memory; and
a processor coupled to the memory and configured to:
receive a chat start instruction from a first information processing terminal and receiving user information acquired by the first information processing terminal;
start a first conversation with a chatbot in the first information processing terminal in response to the chat start instruction;
in a case of receiving transfer information that indicates transfer from the first conversation from a second information processing terminal, start a second conversation that follows the first conversation with the chatbot in the second information processing terminal on the basis of the transfer information; and
start display of different information from the first conversation or different processing from the first conversation in the first information processing terminal on the basis of the received user information.
